(19) United States
(12) Patent Application Publication
(10) Pub. No.: US 2026/0288765 A1
(43) Pub. Date: Sep. 24, 2026

(54) SYSTEM

(71) Applicant: SoftBank Group Corp., Tokyo (JP)

(72) Inventor: Hiroshi SHIBASAKI, Tokyo (JP)

(73) Assignee: SoftBank Group Corp., Tokyo (JP)

(21) Appl. No.: 19/560,167

(22) Filed: Mar. 9, 2026

(30) Foreign Application Priority Data
Mar. 19, 2025 (JP) 2025-044551

(51) Int. Cl. G06F 16/28; G06F 40/205; G06F 40/295; G06N 3/0475

(52) U.S. Cl. CPC G06F 16/287; G06F 40/205; G06F 40/295; G06N 3/0475

(57) ABSTRACT

A system includes a processor that is configured to receive information from a user, analyze the received information and input, into a generative artificial intelligence model, a prompt for instructing generation of a presentation material, and adjust the generated presentation material based on an emotional state of the user.

### CROSS-REFERENCE TO RELATED APPLICATION

This application is based on and claims priority under 35 USC 119 from Japanese Patent Application No. 2025-044551 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional systems for generating presentation materials, a processor typically receives information from a user and automatically creates slides or documents based on predefined templates or simple rule-based logic. Such systems do not adequately take into account the emotional state of the user, even though the user's emotional state, such as anxiety, nervousness, overconfidence, or lack of engagement, significantly influences how information should be structured, emphasized, and visually presented for effective communication. As a result, existing systems often generate presentation materials that are mismatched with the user's psychological condition, for example, by producing overly dense slides for a nervous presenter, or insufficiently detailed materials for a confident expert user. Furthermore, known systems do not fully integrate both quantitative information, such as presentation time and various numerical values, and qualitative information, such as characteristics of a target audience and characteristics of an environment, into a unified process for controlling content, data visualization, and document formatting. Consequently, there is a need for a system that not only uses a generative artificial intelligence model to automatically generate presentation materials from user information, but also analyzes and adjusts the generated presentation materials in accordance with the user's emotional state, while flexibly handling both quantitative and qualitative information.

### SUMMARY

In order to solve the above-described problems, a system is provided that comprises a processor, wherein the processor is configured to receive information from a user, analyze the received information, and input, into a generative artificial intelligence model, a prompt for instructing generation of a presentation material. The processor is further configured to adjust the generated presentation material based on an emotional state of the user. The processor is configured to process quantitative information including at least presentation time and numerical values, and qualitative information including at least characteristics of a target audience and characteristics of an environment, so that the generative artificial intelligence model can be guided to produce content and structure that reflect both numerical constraints and contextual attributes. The processor is also configured to cause the generated presentation material to include data visualizations and document formats suitable for a theme and a target, and to customize information in the generated presentation material in accordance with the emotional state of the user. By generating the prompt on the basis of the quantitative and qualitative information, and by subsequently modifying layout, content density, emphasis, and visual style based on the user's emotional state, the system enables automatic generation of presentation materials that are better aligned with the user's psychological condition, intended audience, and presentation environment.

The term “system” refers to a combination of hardware and software components, including at least one processor and associated memory or interfaces, that cooperatively perform the functions described in the claims.

The term “processor” refers to any hardware device or combination of devices capable of executing instructions, including but not limited to a central processing unit (CPU), a graphics processing unit (GPU), a digital signal processor (DSP), an application specific integrated circuit (ASIC), a field programmable gate array (FPGA), or a combination thereof.

The term “user” refers to a human operator or person who provides information to the system and for whom the presentation material is generated and adjusted.

The term “information” refers to data input by the user, including at least quantitative information and qualitative information, which is used by the processor to generate and adjust the presentation material.

The term “quantitative information” refers to information expressed in numerical form, including at least presentation time, numerical values related to content of the presentation, and other measurable parameters that can constrain or guide the structure of the presentation material.

The term “qualitative information” refers to information expressed in non-numerical form, including at least characteristics of a target audience and characteristics of an environment, and representing attributes, categories, or conditions relevant to the context of the presentation.

The term “target audience” refers to a group of persons who are intended to receive the presentation, and includes, for example, general public audiences, experts, managers, or other specified categories having particular knowledge levels or interests.

The term “environment” refers to circumstances or conditions under which the presentation is delivered, including at least physical or virtual venues, formality levels, and atmosphere characteristics such as formal, casual, or intermediate settings.

The term “generative artificial intelligence model” refers to a machine learning model, such as a neural network-based language model or multimodal model, that is capable of generating content, including text, images, or slide layouts, in response to input prompts.

The term “prompt” refers to a structured input, including text or other representations, provided to the generative artificial intelligence model by the processor to instruct or guide generation of the presentation material.

The term “presentation material” refers to digital content intended for use in a presentation, including but not limited to slides, documents, charts, diagrams, text, and visual elements arranged for display or distribution.

The term “emotional state of the user” refers to a psychological condition or affective status of the user, such as anxiety, nervousness, confidence, excitement, or calmness, which is detected or estimated and used to adjust the presentation material.

The term “analyze” refers to a process performed by the processor to interpret, classify, evaluate, or otherwise process the received information in order to determine parameters, rules, or instructions for generating or adjusting the presentation material.

The term “adjust” refers to modifying, refining, or adapting the generated presentation material, including changing content, emphasis, layout, data visualization, or formatting, based on the emotional state of the user and other parameters.

The term “data visualization” refers to graphical representations of data in the presentation material, including charts, graphs, diagrams, plots, and other visual formats that convey quantitative or qualitative information.

The term “document format” refers to a layout or styling configuration of the presentation material, including font styles, font sizes, color schemes, slide templates, and arrangement of text and images suitable for a theme and a target audience.

The term “theme” refers to a subject, topic, or central idea of the presentation, provided or specified by the user, which guides selection of content, data visualizations, and document formats.

The term “target” refers to an intended recipient or focus entity of the presentation, including a specific type of audience, customer segment, organization, or context, which is used to tailor content and style of the presentation material.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

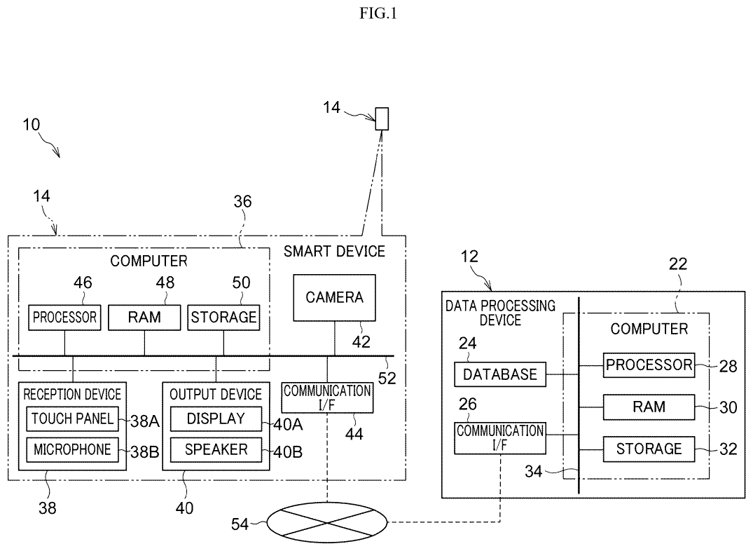

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

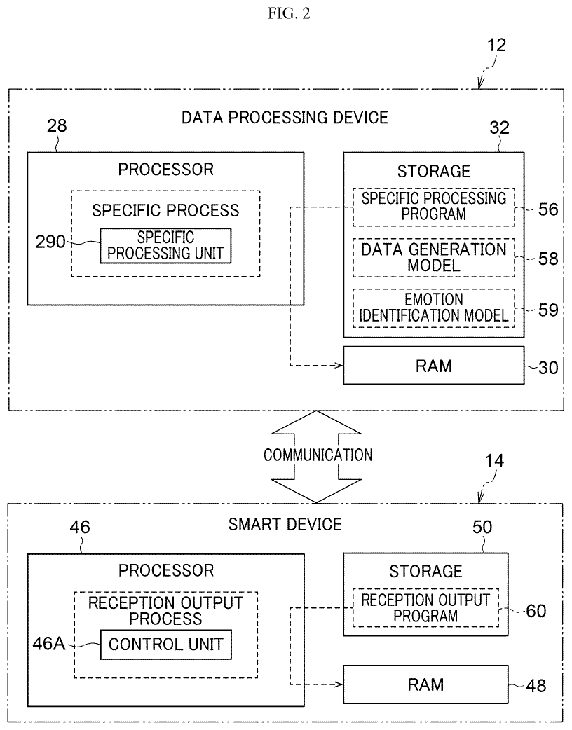

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented presentation authoring tools require a user to manually collect, structure, and rewrite information into slide-ready content. Even when automatic text generation techniques are used, existing systems typically pass unstructured text directly to a generative AI model, without a machine-optimized representation of user inputs or a systematic prompt construction process. As a result, the generated content often lacks alignment with the user's quantitative constraints (such as presentation time or numerical data), qualitative selections (such as target audience or visualization style), and current emotional state, and therefore requires extensive manual post-editing. This leads to increased processing time, inconsistent quality of the generated presentation material, and inefficient utilization of computing resources.

Furthermore, in many existing systems, front-end input handling and back-end generative processing are loosely coupled. User inputs are not normalized into structured data before being sent to a generative AI model, and there is no dedicated server-side mechanism for transforming such structured data into a precise, machine-optimized prompt sentence. Consequently, the generative AI model cannot fully exploit the semantic richness of the user's numerical and selection information, resulting in ambiguous or suboptimal outputs and unnecessary model invocations.

Moreover, conventional systems generally do not treat the user's emotional state as a first-class input signal to the content generation pipeline. There is no standardized server-side logic for acquiring emotion-related information, binding such information to structured data and prompt construction, and dynamically adapting generated slide structure, level of detail, and rhetorical tone. This limits the ability of the computer system to provide personalized and contextually appropriate presentation material, and fails to improve the underlying computer technology for interactive, AI-assisted content generation.

Accordingly, there is a need for a computer-implemented technique that: (i) systematically collects character, numerical, and selection information from a user terminal; (ii) normalizes such information into structured data stored in a storage device; (iii) generates machine-optimized prompt sentences on the server side by using predefined templates and string manipulation; (iv) interacts with a generative AI model in a structured, slide-aware manner; and (v) incorporates emotion-state information into the generation and adjustment of presentation material. Such a technique should improve the overall operation of the computer system by reducing redundant interactions with the generative AI model, improving the determinism and quality of generated output, and enabling efficient production of presentation material that is automatically tailored to user intent and emotional context.

The specific processing by the specific processing unit 290 of the data processing device 12 in Example 1 is realized by the following means.

The present invention provides a server comprising a processor and a storage device, the processor being configured to cause a user terminal to display an input screen that enables a user to input, via the user terminal, character information representing a presentation subject, numerical information, and selection information; receive, from the user terminal via a network, the character information, the numerical information, and the selection information, and store the received character information, numerical information, and selection information as structured data in the storage device; generate, on the basis of the structured data stored in the storage device, a natural language prompt sentence for instructing generation of presentation material, by using a predefined sentence template and string manipulation processing; input the prompt sentence into a generative AI model that generates text information by using natural language processing, and obtain, from the generative AI model, presentation-material text including slide-level structure and bullet-point information; analyze the presentation-material text to generate slide-structure data including slide titles, bullet-point items, and explanatory sentences, and generate, on the basis of the slide-structure data, presentation material in an electronic file format or a web display format; provide the generated presentation material to the user terminal in a state in which the presentation material is downloadable or viewable so that the user can obtain the presentation material; and acquire information relating to an emotional state of the user, and, in accordance with the emotional state, adjust content of at least one of the prompt sentence and the presentation-material text so as to change at least one of an expression style and an information amount of the presentation material. This enables the computer system to internally normalize diverse user inputs into structured data, to generate optimized prompt sentences tailored to the generative AI model, to obtain slide-aware presentation text with reduced ambiguity, and to dynamically adapt the structure, detail level, and tone of the generated presentation material based on the user's emotional state, thereby improving the efficiency, consistency, and technical performance of AI-assisted presentation generation.

The term “user terminal” refers to an information processing device, such as a personal computer, a tablet, a smartphone, or any other computing apparatus, that a user operates to input information, transmit the information to a server via a network, and receive and display generated presentation material.

The term “input screen” refers to a graphical user interface presented on a display of the user terminal that includes one or more input components, such as text boxes, numeric fields, sliders, check boxes, radio buttons, and drop-down menus, through which a user can input character information, numerical information, and selection information.

The term “character information” refers to text data input by a user that expresses at least a subject, theme, or topic of a presentation, and that is represented in a natural language character string.

The term “numerical information” refers to quantitative data input by a user, including but not limited to values representing time, statistical measures, ratios, indices, counts, or any other numerical parameters relevant to the presentation.

The term “selection information” refers to classification data input by a user by means of selecting at least one option from a plurality of options presented on the input screen, the data indicating, for example, a target field, a target group, environmental conditions, an expression policy, a visualization style, or a detail level.

The term “network” refers to a communication infrastructure, including wired or wireless communication links and related protocols, that enables data transmission between the user terminal and the server.

The term “storage device” refers to a computer-accessible memory component, such as a magnetic disk, an optical disk, a semiconductor memory, or a cloud-based storage service, that stores structured data, prompt sentences, and presentation-material data.

The term “structured data” refers to information that has been organized into a predefined data model or data format, such as a record, table, object, or key-value set, in which character information, numerical information, and selection information are associated with corresponding fields or attributes.

The term “prompt sentence” refers to a natural language instruction or query generated by the server, based on the structured data, that is designed to be input into a generative AI model in order to cause the model to generate presentation-material text.

The term “predefined sentence template” refers to a stored pattern or schema of natural language text that includes one or more placeholder portions, and that is used by the server to construct a prompt sentence by substituting processed character information, numerical information, and selection information into the placeholder portions.

The term “string manipulation processing” refers to computer-implemented operations performed on character strings, including concatenation, insertion, replacement, formatting, or reordering, for the purpose of generating grammatically coherent and semantically appropriate prompt sentences.

The term “generative AI model” refers to a computer-implemented model based on machine learning or statistical learning that receives a prompt sentence as input and generates text information as output, using techniques for natural language processing and natural language generation.

The term “presentation-material text” refers to text generated by the generative AI model in response to the prompt sentence, the text including elements such as slide titles, headings, bullet points, and explanatory paragraphs that are suitable for use in presentation material.

The term “slide-level structure” refers to an arrangement of presentation content into discrete logical units corresponding to slides, each unit including at least a title and one or more content elements, such as bullet points or explanatory text.

The term “slide-structure data” refers to structured data derived from the presentation-material text, representing a slide sequence in which each slide includes at least a slide title, one or more bullet-point items, and optionally explanatory sentences or notes.

The term “electronic file format” refers to a digital document format suitable for storing and rendering presentation material, including but not limited to formats for slide documents, text documents, or portable document formats.

The term “web display format” refers to a representation of presentation material using markup language and style definitions, such as hypertext documents and style sheets, that allow the presentation material to be displayed in a web browser.

The term “emotional state” refers to a condition or status associated with a user's affective response, such as stress level, confidence level, interest level, or mood, which is obtained by the system through user input, sensor data, behavioral analysis, or other detection methods.

The term “expression style” refers to characteristics of language used in the presentation material, including tone, formality, level of emphasis, and rhetorical style, which can be adjusted according to the user's emotional state or other conditions.

The term “information amount” refers to a quantity or density of information included in the presentation material, including, for example, a number of slides, a number of bullet points, a level of detail in explanations, or a volume of textual content.

The term “data visualization style” refers to a manner in which numerical or categorical data are represented visually in the presentation material, including types of charts, graphs, tables, or diagrams selected according to the theme, target, or structured data.

The term “layout structure” refers to a spatial arrangement of elements within each slide or page of the presentation material, including placement of titles, text blocks, images, charts, and other components.

The term “text decoration” refers to visual formatting applied to text within the presentation material, including, for example, font type, font size, color, bolding, underlining, or highlighting.

The term “section structure” refers to a higher-level organization of the presentation material into groups of slides or segments, such as introduction, main body, and conclusion, defined according to the theme and target of the presentation.

In one embodiment, a server cooperates with one or more terminals operated by users to generate presentation material by using a generative AI model. The server includes at least one processor, a main memory, a non-volatile storage device, and a network interface. The terminal includes at least one processor, a display, an input device, a memory, and a network interface. The server and the terminal are interconnected via a communication network such as a local area network or a wide area network.

The terminal executes a browser application or a dedicated client application implemented using general-purpose software frameworks. The terminal renders a graphical user interface that constitutes an input screen. The terminal displays, on the input screen, one or more text boxes, numeric input fields, sliders, check boxes, radio buttons, and drop-down menus. The terminal allows a user to input character information representing a presentation subject, numerical information related to the subject, and selection information specifying conditions such as a target field, a target group, environmental conditions, an expression policy, a visualization style, and a detail level.

The terminal converts each user operation on the input screen into structured request data. The terminal associates the character information with a first field, the numerical information with a second field, and the selection information with a third field in an internal data object. The terminal serializes the data object into a machine-readable format such as a structured text format and transmits the serialized data to the server over the network by using a transport protocol such as hypertext transfer protocol over secure sockets.

The server receives the structured request data via the network interface and stores the data in a storage device. The server uses a data management module to map the received data into one or more records in a database. The server stores the character information, the numerical information, and the selection information as structured data associated with an identifier. The server normalizes the numerical information by converting raw values into typed quantities, such as durations, percentages, and counts, and by enforcing constraints such as permitted ranges. The server normalizes the selection information by mapping option identifiers into domain-specific labels indicating, for example, a business domain, an academic field, or a technical area.

The server constructs a context representation from the structured data stored in the storage device. The server uses a data-structuring module to group the character information, the normalized numerical information, and the normalized selection information into a structured context object. The server associates each element of the context object with semantic tags, such as “topic_description,” “time_constraint,” “key_metric,” “target_audience,” and “visualization_preference.” The server uses this tagged context to control subsequent prompt sentence generation, thereby improving determinism and reducing ambiguity in the data flow to the generative AI model.

The server generates a prompt sentence by using a template-based natural language construction module. The server stores one or more predefined sentence templates in the storage device. Each sentence template includes fixed text fragments and placeholder regions corresponding to semantic tags. The server retrieves an appropriate template based on at least one of the selection information and the type of numerical information, and the server fills the placeholder regions by performing string manipulation processing. The server performs operations such as concatenation, insertion, and formatting of character strings, while enforcing grammatical rules such as subject-verb agreement and tense consistency. Because the server uses structured semantic tags and dedicated templates, the server can generate prompt sentences that are optimized for machine interpretation by the generative AI model.

In a concrete example, the user inputs the following: a presentation subject “The importance of environmental protection,” numerical information “CO2 emissions in 2023 increased by 5% compared to the previous year,” and selection information “Expansion of renewable energy use is necessary and include policy recommendations.” The server maps those inputs into semantic tags and constructs a prompt sentence such as: “Please create a presentation about the importance of environmental protection. In this presentation, explain that CO2 emissions in 2023 increased by 5% compared to the previous year. Emphasize that an expansion of renewable energy use is necessary and include policy recommendations. Structure the output as slide titles with bullet points and short speaker notes suitable for use in a professional business presentation.”

The server inputs the generated prompt sentence into a generative AI model. In one embodiment, the generative AI model is implemented as a multi-layer neural network with an encoder-decoder or decoder-only transformer architecture. The model includes an embedding layer that converts tokens of the prompt sentence into dense vectors, multiple attention layers that compute contextual relationships between tokens, feedforward layers that transform intermediate representations, and an output layer that predicts a next token distribution.

The server configures the generative AI model with parameters such as a number of layers, a number of attention heads, hidden layer sizes, and vocabulary size. The server trains or uses a model that has been trained on large-scale natural language corpora. During training, the server or a training system uses a loss function such as a cross-entropy error between predicted token distributions and target token sequences. The server updates model parameters by using an optimization algorithm such as stochastic gradient descent with momentum, adaptive moment estimation, or related methods. The server may employ data augmentation techniques such as text paraphrasing or masked token prediction to increase robustness. The server thereby uses a model that has internal parameters optimized to generate coherent and contextually appropriate text in response to structured prompt sentences.

The server controls the generative AI model in a non-conventional way by embedding slide-structure hints in the prompt sentence. The server includes explicit instructions such as “Output slide titles labeled as ‘Slide 1:’, ‘Slide 2:’” and “Use bullet points under each slide title.” This directive structure is not equivalent to a human merely asking another human to write slides; rather, the server systematically constrains the output format by combining structured tags and template rules so that the generative AI model produces text that can be automatically parsed into slide-structure data. This improves internal parsing accuracy and reduces post-processing complexity.

The server receives the generated presentation-material text from the generative AI model and converts it into slide-structure data. The server executes a parsing module that scans the generated text based on markers such as “Slide 1:”, “Slide 2:”, bullet delimiters, and line breaks. The server converts contiguous text segments into structured objects, each object containing a “title” field, a “bullets” list, and an optional “notes” field. The server uses deterministic parsing rules, such as treating lines starting with a bullet marker as bullet items and treating the first line after a slide label as a slide title. This rule-based conversion allows the server to avoid ambiguity and ensures that slide boundaries are consistently recognized across different generations.

The server generates presentation material in an electronic file format or a web display format by using the slide-structure data. In one embodiment, the server uses a document generation library to construct a slide document. The server creates a new presentation file in a slide format, creates a slide for each slide-structure object, sets the slide title text into a title text box, and inserts each bullet-point item into a bullet list object. The server configures layout structure attributes such as font type, font size, color, and positioning on each slide. The server optionally incorporates visual elements such as charts and tables based on the numerical information; for example, when the numerical information includes a time series, the server selects a line chart; when the numerical information includes category ratios, the server selects a bar chart or pie chart.

The server acquires information relating to an emotional state of the user. The terminal may display a simple scale or multiple-choice selector asking the user to indicate a current emotional state, such as “confident,” “nervous,” or “neutral.” The terminal may further provide sensor-based data, such as heart rate information or gaze pattern data, if available. The terminal transmits the emotional state data as part of the structured request data. The server maps those inputs to an internal emotional state parameter, for example, a vector indicating confidence level, stress level, and engagement level.

The server adjusts at least one of the prompt sentence and the presentation-material text based on the emotional state parameter. For a user with a high stress level and low confidence level, the server may generate a prompt sentence that explicitly requests more detailed speaker notes and a lower density of information per slide. For example, the server may generate: “Please create a presentation that is easy to present for a beginner speaker. Use short bullet points and include clear, supportive speaker notes that explain each point in simple terms. Limit each slide to no more than four bullet points.”

For a user with a high confidence level, the server may request more compact slides and more advanced terminology. By altering the structure of the prompt sentence based on emotional state parameters, the server modifies the internal conditions under which the generative AI model generates the presentation-material text. This adjustment changes slide count, bullet density, explanation depth, and tone without requiring the user to manually rewrite large portions of the presentation.

The server thereby improves the technical operation of the computer system in several ways. First, by normalizing user inputs into structured data and using template-based generation of prompt sentences, the server reduces variance in model input and increases the predictability of the generative AI model's output. This leads to higher parsing accuracy and reduced need for repeated model calls, which in turn lowers computational load and network traffic. Second, by embedding structure-inducing instructions into the prompt sentence and using deterministic parsing rules, the server reduces post-processing errors and accelerates conversion from generative text to slide-structure data, improving overall processing speed. Third, by adjusting prompt sentences and output formats based on emotional state parameters in a systematic manner, the server optimizes output length, density, and tone automatically, thereby reducing user-side editing time and further reducing redundant server-side regenerations.

The server implements the generative AI model as a modular software component. The server includes an interface module that formats requests to the model, an inference module that executes the forward pass of the neural network on computing hardware such as central processing units and graphics processing units, and a result-handling module that decodes predicted tokens into character strings. The server may integrate a cache mechanism that stores recently used prompt sentences and corresponding outputs, enabling reuse when the structured data difference is within a predetermined threshold. This caching reduces the number of full forward passes required by the generative AI model and thus improves computational efficiency.

The server further uses a scheduling module to manage multiple concurrent requests from different terminals. The server assigns priorities based on factors such as request complexity, user type, or time constraints derived from the numerical information. By batching requests with similar structure or length, the server can send grouped inputs to the generative AI model in a single batch operation, which improves throughput and reduces overhead associated with repeated initialization of model inference processes.

In another embodiment, the server employs alternative generative AI models. The server may use a smaller model for low-latency scenarios or an ensemble of models for higher accuracy. The server may also apply a rule-based post-processing model that corrects typical slide-generation errors, such as missing titles or excessive bullet points per slide. The server may implement a meta-heuristic algorithm that evaluates slide-structure data based on heuristics such as maximum slide length and average bullet count, and then triggers selective regeneration of only problematic slides by constructing localized prompt sentences.

In a further embodiment, the server maintains multiple prompt templates tailored to different application domains, such as business presentations, academic lectures, or technical briefings. The server selects a template based on the selection information regarding the target field. For example, when the user selects a technical field, the server uses a template that emphasizes definitions, system architecture, and data flow. When the user selects an educational field, the server uses a template that emphasizes learning objectives and step-by-step explanations. This template selection mechanism causes the generative AI model to generate domain-appropriate content without requiring a separate model for each domain, thus making efficient use of computing resources.

The terminal uses the presentation material generated by the server to present content in real time. The terminal downloads the electronic file and displays slides in a presentation mode, or loads a web display format and renders slides in a browser. The terminal can also receive incremental updates from the server if the user modifies inputs or emotional state parameters during preparation. The server may regenerate only affected portions of the presentation, such as notes sections, based on new emotional state parameters, thereby maintaining responsiveness and reducing the need for full document regeneration.

The described system, by tightly integrating structured data handling, template-based prompt sentence generation, model-specific formatting, deterministic parsing, and emotion-aware post-adjustment, achieves a technical improvement over conventional systems that merely transmit free-form text to a generative model. The server modifies internal data structures, controls model invocation patterns, and constrains formatting rules in ways that a human performing the task manually cannot replicate with the same speed or consistency. As a result, the system provides improved processing speed, reduced error rate in slide structuring, more efficient utilization of computing and network resources, and enhanced adaptability of presentation material to user conditions.

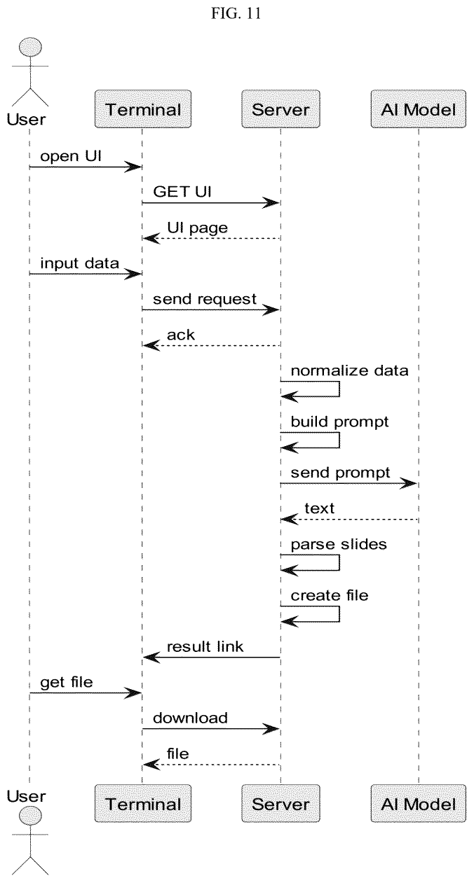

The following describes the processing flow using FIG. 11.

### Step 1:

The terminal displays an input screen to the user. The terminal loads a web page or client view that contains a text box for character information, numeric fields or sliders for numerical information, and selection components such as check boxes, radio buttons, and drop-down menus for selection information.

Input: GUI configuration data received from the server and rendered by the terminal.

Output: A visible input screen that allows the user to enter a presentation subject, numerical values, and selection options.

### Step 2:

The user inputs presentation-related information via the terminal. The user types a presentation subject into the text box, enters numerical values into numeric fields or adjusts sliders, and chooses one or more options from the selection components.

Input: The displayed input screen and user operations (keystrokes, mouse clicks, touch gestures).

Output: A set of raw input values held in the terminal's memory, including character strings, numeric values, and selected option identifiers.

### Step 3:

The terminal structures the user input into a request object. The terminal maps the text box content to a character information field, the numeric field and slider values to a numerical information field, and the selected options to a selection information field. The terminal then validates formats (for example, confirming that numbers are within allowed ranges) and serializes the structured object into a machine-readable format.

Input: Raw input values collected from the GUI components.

Output: A structured request object containing character information, numerical information, and selection information, ready for transmission to the server.

### Step 4:

The terminal transmits the structured request object to the server. The terminal sends an HTTP or similar network request that includes the structured data as a payload. The terminal ensures that identifiers such as user ID or session token are attached for association on the server side.

Input: The structured request object generated in Step 3.

Output: A network message containing user input data delivered to the server.

### Step 5:

The server receives and parses the request object. The server reads the incoming network message, extracts the payload, and deserializes it into internal data structures such as records or objects. The server verifies integrity (for example, checking that all required fields are present) and rejects incomplete or inconsistent data.

Input: The network message containing structured character, numerical, and selection information.

Output: An internal representation of the user's input, stored as in-memory structures available for further processing.

### Step 6:

The server normalizes numerical information. The server converts raw numeric values to canonical formats, such as converting “5” into a percentage string “5%” or into a duration “5 minutes,” depending on context. The server applies range checks, unit conversions, and rounding rules.

Input: Raw numerical values from the internal representation.

Output: Normalized numerical information tagged with types (for example, percentage, time duration, count) and stored in fields suitable for use in prompt construction.

### Step 7:

The server normalizes selection information. The server converts selection identifiers (such as option codes) into descriptive labels, such as “technical audience,” “business audience,” “detailed explanation,” or “high-level summary.” The server maps each option to semantic tags like target field, target group, visualization style, and detail level.

Input: Raw selection identifiers from the internal representation.

Output: A set of normalized selection descriptors and semantic tags stored in the server's context object.

### Step 8:

The server constructs a context object from the normalized data. The server aggregates the character information (presentation subject), normalized numerical information, and normalized selection information into a single structured object. The server assigns semantic keys such as “topic_description,” “time_constraint,” “key_metric,” “target_audience,” and “visualization_preference,” and binds each key to corresponding content.

Input: Character information, normalized numerical information, and normalized selection descriptors.

Output: A context object that expresses the user's intent and constraints in a structured, semantically tagged form.

### Step 9:

The server selects a sentence template based on the context object. The server examines semantic tags in the context object, such as target field and detail level, and chooses one of several predefined natural language templates optimized for the generative AI model. For example, the server may select a “business pitch” template or an “educational lecture” template.

Input: The context object containing semantic tags.

Output: A selected sentence template whose placeholders correspond to elements in the context object.

### Step 10:

The server generates a prompt sentence using the template and context object. The server fills the template placeholders with values from the context object, performing string manipulation operations such as concatenation, insertion, number formatting, and grammatical adjustments. The server ensures that the resulting prompt sentence includes explicit instructions about slide structure and bullet points.

Input: The selected sentence template and the context object.

Output: A fully constructed prompt sentence that instructs generation of presentation material by the generative AI model.

### Step 11:

The server optionally modifies the prompt sentence according to the user's emotional state. The server reads emotion-related parameters (such as confidence level or stress level) and adjusts parts of the prompt sentence to request more detailed speaker notes, fewer bullet points per slide, or a more supportive tone.

Input: The initial prompt sentence and emotional state parameters.

Output: An emotion-adjusted prompt sentence that tailors the future output's structure and tone to the user's condition.

### Step 12:

The server prepares a model invocation request. The server selects a generative AI model configuration (for example, model size, maximum output length, temperature value) consistent with the context. The server packages the prompt sentence and model parameters into a request structure designed for the inference engine or external AI service.

Input: The finalized prompt sentence and system configuration data.

Output: A model invocation request object ready for submission to the generative AI model.

### Step 13:

The server invokes the generative AI model with the prompt sentence. The server passes the request to the model inference module, which tokenizes the prompt sentence into discrete tokens, converts tokens into embeddings, and executes a forward pass through the neural network layers.

Input: The model invocation request including the prompt sentence and parameters.

Output: A sequence of predicted tokens that form the presentation-material text in a model-internal representation.

### Step 14:

The server decodes the model output into presentation-material text. The server converts predicted token IDs back into characters and words, assembles them into sentences, and forms a continuous text string. The server may apply post-decoding filters, such as removing incomplete trailing sentences or ensuring that required markers (for example, “Slide 1:”) are present.

Input: The token sequence produced by the generative AI model.

Output: Human-readable presentation-material text that follows the requested structure.

### Step 15:

The server parses the presentation-material text into slide-structure data. The server scans the text for markers such as “Slide 1:”, “Slide 2:”, and bullet-point indicators (such as leading dashes or bullets). The server splits the text into segments at slide markers, and within each segment, separates the slide title from bullet points and any explanatory notes.

Input: The presentation-material text generated in Step 14.

Output: Slide-structure data including a list of slide objects, each containing a title, a set of bullet items, and optional notes.

### Step 16:

The server enriches the slide-structure data with layout and visualization metadata. The server examines numerical information and selection tags to determine chart types, table presence, or special emphasis. The server assigns attributes such as “use bar chart,” “highlight key metric,” or “include summary box” to relevant slides.

Input: The slide-structure data and the original context object (including numerical and selection information).

Output: Enhanced slide-structure data that includes both content and layout/visualization hints.

### Step 17:

The server generates electronic presentation material from the slide-structure data. The server creates a presentation document in a chosen file format or generates a set of web pages. The server iterates through slide objects, creates corresponding slides, inserts titles and bullet points, and applies layout metadata to define positions, font styles, and colors.

Input: The enhanced slide-structure data.

Output: A presentation file or web-based presentation material containing structured slides ready for viewing.

### Step 18:

The server stores the generated presentation material. The server writes the presentation file to a storage device and updates a database with a record linking the file location to the user identifier and original context identifier. The server may store metadata such as generation time, number of slides, and size of the output.

Input: The generated presentation material and context identifiers.

Output: A persistent record and file stored on the server, retrievable by reference.

### Step 19:

The server notifies the terminal about availability of the presentation material. The server sends a response message that includes a reference to the stored file or a direct download or viewing URL, along with metadata such as file format and slide count.

Input: The stored file reference and associated metadata.

Output: A notification message to the terminal specifying how to access the presentation material.

### Step 20:

The terminal receives the notification and presents access options to the user. The terminal parses the response message, displays a link or button labeled, for example, “Download presentation” or “View slides,” and may show summary information such as the number of slides.

Input: The notification message from the server.

Output: An updated user interface that allows the user to initiate download or viewing of the generated presentation.

### Step 21:

The user obtains and reviews the generated presentation material. The user activates the provided link or button on the terminal, causing the terminal to download the file or load the web presentation. The user then views the slides, evaluates content, and may decide whether further adjustments are needed.

Input: The access options displayed on the terminal.

Output: User-side access to and visualization of the generated presentation, which can lead to new or modified input in a subsequent iteration.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented presentation generation systems typically accept manually prepared outline text or static numerical data and then apply generic template filling to produce slides or documents. Such systems do not effectively exploit large-scale operational data or quality data generated by industrial processes, and therefore fail to provide presentation materials that contain deeply data-driven improvement plans or operational insights. In particular, existing systems generally treat numerical data and free-text feedback independently and do not integrate them into a unified machine-understandable representation that can be leveraged by a generative AI model in a systematic and repeatable manner.

In addition, in conventional approaches, preprocessing of industrial data, such as production records and quality evaluation logs, is often carried out by human analysts using ad hoc tools. This leads to inconsistent handling of missing values, outliers, and derived performance indicators, and prevents the construction of a stable, automated data pipeline from raw industrial data to presentation-ready content. As a result, the generating of operational improvement presentations is time-consuming, error-prone, and not scalable across different facilities or users.

Furthermore, existing generative AI integrations frequently pass only simple, unstructured prompts to a model, without embedding machine-calculated indicators such as production-efficiency indicators, defect-rate indicators, and operation-status indicators. This limits the model's ability to output precise and contextually grounded proposals, and often produces text that is generic or misaligned with the actual state of the industrial process. The prompt construction itself is typically performed manually by a user, which introduces variability and relies on the user's expertise to craft effective prompts.

Moreover, known systems rarely adapt the generated presentation structure, information density, or expression format in response to a user's emotional state or cognitive load. The same level of detail and presentation order is delivered regardless of whether the user is stressed, inattentive, or highly focused, which can reduce the effectiveness of communication and hinder decision-making in time-critical industrial environments.

Accordingly, there is a need for a computer-implemented technique that systematically: (i) acquires and preprocesses structured industrial data, (ii) computes standardized performance indicators from such data, (iii) programmatically constructs rich, model-ready prompt sentences that integrate both user-provided information and computed indicators, (iv) invokes a generative AI model to produce structured presentation-material candidate text containing concrete improvement plans, and (v) automatically organizes, visualizes, and adaptively presents the generated content in a manner responsive to the user's emotional state. Such a technique should improve the functioning of a computer system by providing a specific data-processing pipeline and model interaction protocol, thereby enabling more accurate, context-aware, and user-adaptive generation of presentation materials.

The specific processing by the specific processing unit 290 of the data processing device 12 in Application Example 1 is realized by the following means.

The present invention provides a server comprising a processor and a memory storing instructions which, when executed by the processor, cause the processor to receive, via a client terminal, information indicating a presentation theme and purpose, quantitative information, and qualitative information from a user; to obtain, from the client terminal, structured information files including work performance information and quality evaluation information related to an industrial process, convert the structured information files into tabular data, and perform missing-value processing, outlier processing, aggregation processing, and index-calculation processing on the tabular data to generate analysis data; to integrate the information indicating the presentation theme and purpose, the quantitative information, and the qualitative information with summary information and performance indicators calculated from the analysis data, and construct a prompt sentence as an input sentence for a generative AI model; to input the prompt sentence to the generative AI model and cause the generative AI model to generate presentation-material candidate text including improvement plans for work planning and quality improvement plans for the industrial process; to segment the presentation-material candidate text into plural display units including explanatory sections, list sections, and heading sections, and associate numerical information and visualization information based on the analysis data with the respective display units; to generate a document for visual presentation based on the structured presentation material and provide the document to the client terminal; and to adjust a presentation order, an information amount, and an expression format of the generated presentation material in accordance with an emotional state of the user. This enables a computer system to automatically transform raw industrial data and user inputs into a model-ready prompt, invoke a generative AI model in a structured manner, and deliver data-grounded and user-adaptive presentation materials, thereby improving the technical process of generating operational presentations in terms of automation, consistency, contextual accuracy, and adaptability to the user's state.

The term “processor” refers to a hardware computation unit or a combination of hardware computation units configured to execute instructions, perform arithmetic and logical operations, and control data flows in the system.

The term “terminal” refers to any user-operated electronic device capable of communicating with the server over a communication network and presenting a user interface, including but not limited to a mobile device, a tablet device, a desktop device, or a web browser.

The term “user” refers to a human operator who provides input information to the system, reviews generated presentation materials, and makes operational decisions based on the presented information.

The term “presentation theme and purpose” refers to information indicating a main topic, objective, or intended outcome of a presentation, such as improvement of an industrial process, reporting of operational status, or proposal of action items.

The term “quantitative information” refers to information that is represented by numerical values or measurable metrics, including but not limited to production volumes, defect rates, processing times, and target performance values.

The term “qualitative information” refers to information that is represented by descriptive or evaluative expressions rather than numerical values, including but not limited to operator feedback, observed issues, contextual descriptions, and management priorities.

The term “structured information file” refers to a machine-readable data file in which industrial data is arranged according to a predefined structure, such as a delimited text file, a spreadsheet file, or another tabular format, and which includes explicit fields for work performance information and quality evaluation information.

The term “work performance information” refers to information related to execution results of an industrial process, including but not limited to production quantities, operation times, equipment states, and process conditions, recorded on a time basis or period basis.

The term “quality evaluation information” refers to information used to assess and record quality characteristics of products or processes, including but not limited to inspection results, defect classifications, defect counts, and quality grades.

The term “tabular data” refers to data represented in a two-dimensional structure composed of rows and columns, such as a data table or a data frame, in which each column corresponds to an attribute and each row corresponds to a record.

The term “missing-value processing” refers to a data processing operation for detecting absent or undefined values in the tabular data and replacing, imputing, or otherwise handling such values according to predefined rules.

The term “outlier processing” refers to a data processing operation for detecting anomalous or extreme values in the tabular data, based on statistical criteria or threshold criteria, and modifying, capping, or removing such values according to predefined rules.

The term “aggregation processing” refers to a data processing operation for grouping multiple data records and combining them into summarized values, such as sums, averages, counts, or other statistical aggregates, over a defined time period, product category, or process unit.

The term “index-calculation processing” refers to a data processing operation for computing one or more indicators or indices from the tabular data, such as efficiency indicators, defect-rate indicators, or operation-status indicators, using arithmetic or statistical formulas.

The term “analysis data” refers to tabular data that has been subjected to missing-value processing, outlier processing, aggregation processing, and index-calculation processing, and that is ready to be used for generating summary information and performance indicators.

The term “summary information” refers to textual or numerical descriptions derived from the analysis data, including but not limited to averages, trends, comparisons, and condensed statements representing a state of the industrial process.

The term “performance indicator” refers to a numerical metric calculated from the analysis data for evaluating performance of an industrial process, including but not limited to a production-efficiency indicator, a defect-rate indicator, and an operation-status indicator.

The term “production-efficiency indicator” refers to a performance indicator representing a relationship between actual production output and available or planned production resources, which may include throughput, utilization, or other measures of production effectiveness.

The term “defect-rate indicator” refers to a performance indicator representing a ratio or frequency of defective units or quality failures relative to total produced units or inspected units.

The term “operation-status indicator” refers to a performance indicator representing a state of equipment or process operation over time, including but not limited to uptime, downtime, stoppage frequency, or load factor.

The term “prompt sentence” refers to a machine-readable sequence of characters or tokens that is constructed as input for a generative AI model and that includes user-provided information, analysis results, and instructions for generating presentation-material content.

The term “generative AI model” refers to a trained information processing model, such as a machine learning model or a neural network model, configured to generate new data, including natural-language text, based on input data and learned parameters.

The term “presentation-material candidate text” refers to machine-generated textual content output by the generative AI model in response to the prompt sentence, including explanations, improvement plans, and other narrative elements suitable for presentation use.

The term “improvement plan for work planning” refers to a set of proposed actions or scheduling changes derived from the generative AI model output for enhancing efficiency or effectiveness of operational planning in an industrial process.

The term “quality improvement plan” refers to a set of proposed actions or procedural changes derived from the generative AI model output for reducing defects or enhancing quality performance in an industrial process.

The term “display unit” refers to a logical segment of the presentation material, such as an explanatory section, a list section, or a heading section, that can be rendered as a slide, a block, or another discrete unit on a display device.

The term “explanatory section” refers to a display unit containing one or more sentences or paragraphs that describe context, analysis results, or interpretations in narrative form.

The term “list section” refers to a display unit containing items arranged as a list, such as bullet points or numbered points, representing key issues, proposals, or steps.

The term “heading section” refers to a display unit containing a short title or label that indicates a topic or section name of the presentation material.

The term “numerical information” refers to values expressed as numbers, including raw values, aggregated values, and calculated indicators derived from the analysis data.

The term “visualization information” refers to information encoded in a graphical or visual form, such as charts, graphs, or diagrams, that represent numerical information or analysis data for human viewing.

The term “document for visual presentation” refers to a machine-generated electronic document, such as a markup document, a slide document, or a page-based document, that is formatted to be displayed on a screen or printed for use in a presentation.

The term “emotional state of the user” refers to a mental or affective condition of the user, such as stress level, engagement level, or receptiveness, detected or inferred by the system and used to adapt presentation order, information density, or expression style.

The term “presentation order” refers to a sequence in which display units or sections of the presentation material are arranged and presented to the user.

The term “information amount” refers to a quantity or density of information included within a display unit or a series of display units, such as a number of items, level of detail, or depth of explanation.

The term “expression format” refers to a manner in which information is presented, including but not limited to linguistic style, level of technicality, layout style, and emphasis techniques applied to the presentation material.

In one embodiment, a server, a terminal, and a communication network cooperate to implement a system for generating presentation materials based on industrial data and user input. The server includes at least one processor, a main memory, a non-transitory storage device, and a network interface. The terminal includes a processor, a display device, an input device, and a communication module. The server and the terminal communicate over a wired or wireless network using a standard communication protocol.

The server executes an operating system and an application stack that includes a web application framework, a data-processing library, and a machine learning framework. In one embodiment, the server uses a web framework such as a generic server-side web framework, a data-processing library such as a generic tabular data library, and a machine learning framework such as a generic tensor computation framework. The server further stores a trained generative AI model in the non-transitory storage device and loads parameters of the generative AI model into the main memory when executing the application.

The terminal executes a web browser application to render user interfaces delivered from the server. The terminal displays form components such as text boxes, numeric fields, text areas, selection boxes, and file upload elements. The user operates the terminal to input information into these form components. The terminal transmits the information to the server by issuing network requests that encode the form data in a predefined message format.

The server receives, via the network interface, information indicating a presentation theme and purpose, quantitative information, and qualitative information. The server stores this information in a database management system that resides on the server or on a separate storage apparatus. The database stores, for each presentation session, a theme field, a quantitative-information field, a qualitative-information field, and metadata fields such as timestamps and user identifiers. By structuring the data in this manner, the server can later retrieve and systematically combine the information with industrial data.

The server obtains structured information files from the terminal. In one embodiment, the terminal transmits comma-separated-value files that contain work performance information and quality evaluation information related to an industrial process. The server stores the files in a file storage area and then loads the contents into an in-memory tabular data structure, such as a two-dimensional array or a data frame, using the data-processing library. Each column of the tabular data structure corresponds to an attribute, such as a timestamp, a production quantity, a defect count, a category code, or an equipment identifier. Each row corresponds to an individual record, such as a measurement at a particular time.

The server performs missing-value processing by scanning the tabular data structure for empty or invalid entries in specified columns. The server applies a predefined rule set that specifies, for each column type, how to impute the missing values. For example, the server can compute a mean, median, or last-observation-carried-forward value for a column and then write that value into the missing entries. This automated, column-specific imputation improves data consistency and reduces noise before analysis.

The server performs outlier processing by computing, for each metric column, a statistical descriptor such as a mean and a standard deviation, or a quantile range. The server identifies values that exceed a threshold, for example, values more than a predetermined number of standard deviations away from the mean. The server replaces such values with capped values or marks the corresponding rows for exclusion from further calculations. By standardizing outlier handling in the tabular data structure, the server reduces the impact of anomalous measurements on subsequent performance indicators, thereby improving the robustness of the analysis.

The server performs aggregation processing by grouping the tabular data along dimensions such as time intervals, product types, or equipment units. The server computes aggregate metrics such as a total production quantity per day, an average defect rate per product, or a downtime count per shift. The server writes the resulting aggregates into new tables or data frames, which represent higher-level views of the industrial process. This multi-level aggregation reduces the volume of data that must be processed in subsequent stages, which improves computational efficiency and reduces memory usage.

The server performs index-calculation processing by applying predefined formulas to the aggregated data. For example, the server calculates a production-efficiency indicator by dividing an actual output by a planned capacity and optionally multiplying by a scaling factor. The server calculates a defect-rate indicator by dividing a number of defective units by a total number of produced units. The server calculates an operation-status indicator by computing a ratio of operating time to total available time. These indicators are stored as numeric fields in the analysis data structure, which is distinct from the original raw data structure.

The server generates analysis data by combining the cleansed, aggregated, and index-enriched tables into a unified representation. In one implementation, the server maintains a hierarchical data structure that associates, for each presentation session, the raw tables, the aggregated tables, and a summary table of indicators. The server also generates textual summary information for each key indicator, such as “Average daily production volume is 1,050 units” or “Current defect rate is 2.3 percent,” by formatting indicator values into templated sentences. These summaries are stored as text fields linked to the corresponding numeric fields, which enables the server to reuse both numeric and textual forms in later steps.

The server constructs a prompt sentence as a machine-readable sequence of characters that serves as input to the generative AI model. The server forms the prompt sentence by concatenating the presentation theme and purpose, the quantitative information, the qualitative information, the generated textual summaries, and explicit instruction text. The server inserts section markers and labels into the prompt sentence to guide the generative AI model to output structured sections such as “Current Situation,” “Main Issues,” “Improvement Proposals,” and “Expected Effects.” In one example, the server constructs the following prompt sentence:
“The theme of the presentation is: ‘Proposal to improve this month's production efficiency.’
Quantitative information:
Target production volume per day: 1,200 units.
Acceptable defect rate: 1.5%.
Operating hours per day: 16 hours.
Data summary from the last 3 months (from CSV analysis):
Average daily production volume: 1,050 units.
Current defect rate: 2.3%.
Frequent defect categories: surface scratches and dimensional errors.
Peak downtime periods: night shift between 1:00 and 3:00.
Qualitative information:
Operators report frequent minor stoppages on Line B due to material supply delays.
Quality inspectors note an increase in defects after maintenance activities.
Using the above data, please, as a generative AI model, generate content for presentation slides that includes:
1. A clear summary of the current production and quality status.
2. The main factors that are reducing production efficiency.
3. Concrete improvement proposals for production planning, equipment operation, and quality control.
4. Quantitative expectations for improvement (for example, potential increase in output and reduction in defect rate).
5. A logical slide structure with section titles and bullet points, ready to be converted into presentation material.”

The server tokenizes the prompt sentence by applying a tokenizer associated with the generative AI model. The tokenizer maps substrings of the prompt sentence to integer token identifiers, which are then arranged in a sequence. The server pads or truncates the token sequence according to a maximum input length parameter and stores the resulting sequence in a tensor format suitable for the machine learning framework.

The server executes the generative AI model by supplying the input tensor to a neural network architecture. In one embodiment, the generative AI model includes a transformer-based encoder-decoder network with multiple layers of self-attention and feed-forward sublayers. Each layer applies matrix multiplications between token embeddings and learned parameter matrices, followed by non-linear activation functions and normalization operations. During training, the model learns to minimize a sequence-based loss function, such as a cross-entropy loss between predicted tokens and ground-truth tokens. The server executes the inference phase of the model using the trained parameters stored in the non-transitory storage device.

The server performs decoding by iteratively generating output tokens until an end-of-sequence token or a maximum length is reached. The server can apply a beam search algorithm to maintain multiple candidate sequences and select the one with the highest overall probability. Alternatively, the server can apply a top-k sampling or nucleus sampling algorithm to balance diversity and coherence. The server assembles the generated token sequence into a character string, which constitutes the presentation-material candidate text.

The server structures the presentation-material candidate text by scanning for markers such as headings, enumeration markers, and paragraph breaks that were induced by the prompt sentence and by the generative AI model behavior. The server splits the text into display units, including explanatory sections, list sections, and heading sections. Each display unit is represented by a record in a data structure that contains a section type, a title, and one or more content blocks. The server further associates numeric fields and visualization specifications with particular display units. For example, the server may associate a production-efficiency indicator with a slide titled “Current Production Efficiency,” and associate a defect-rate trend chart with a slide titled “Quality Issues.”

The server generates visualization information using the data-processing library and a charting library. The server selects a chart type, such as a line chart for time series of production volume or a bar chart for defect counts by category. The server creates a figure in memory and plots the relevant indicator values. The server then encodes the chart as an image file or as a scalable graphic representation and stores a reference to the visualization in the presentation structure. This approach reduces the number of raw data points that must be rendered on the terminal and minimizes the load on the network by transmitting compact graphical representations instead of raw data tables.

The server generates a document for visual presentation by applying a template system to the structured presentation data. The server merges the text content, the numeric indicators, and the visualization references into layout templates that define positions, fonts, colors, and styles for each display unit. The result may be an HTML document, a slide description document, or another structured document suitable for display on the terminal. By separating the content structure from the layout template, the server can reuse the same content for different output formats, such as a web-based slideshow or a printable document.

The server determines an emotional state of the user by processing signals such as interaction patterns, response times, or explicit feedback obtained via the terminal. For example, the server may infer a high-stress state if the user rapidly skips through slides without reading, or infer a low-engagement state if the user remains idle on a slide for an extended period without interaction. The server stores a representation of the inferred emotional state as an internal parameter or flag.

The server adjusts a presentation order, an information amount, and an expression format based on the emotional state. When the server detects a stressed user, the server can reorder slides to show key summaries and high-priority recommendations earlier, while postponing detailed technical analysis. The server can also reduce the number of bullet points per slide or provide shorter, more direct sentences. When the server detects a stable or highly engaged state, the server can increase the information amount by inserting supplementary slides, detailed explanations, or additional charts. This adaptive behavior constitutes a non-conventional, rule-based control of information flow inside the server, which improves usability and reduces cognitive overload.

The server thereby improves the functioning of the computer system in several technical ways. By applying standardized, automated preprocessing to industrial data (including missing-value processing, outlier processing, aggregation processing, and index-calculation processing) before constructing the prompt sentence, the server reduces noise and dimensionality in the data fed to the generative AI model. This reduces computation time during inference, improves convergence of the neural network's internal activations, and yields more accurate and stable outputs. By generating a structured, indicator-rich prompt sentence programmatically, the server reduces prompt variability and ensures that the generative AI model consistently receives machine-calculated performance indicators together with qualitative context, which increases the precision and relevance of the generated text compared to a purely manual prompting approach.

The server also improves data management by maintaining a layered data structure that separates raw measurements, processed analysis data, and presentation-level content. This architecture facilitates caching of intermediate results, enables incremental updates when new industrial data arrives, and minimizes redundant computations. As a result, the server can regenerate updated presentation materials more quickly when new data is uploaded, thereby improving processing speed and reducing computational load.

The server's use of a transformer-based neural network architecture with predefined hyperparameters, a specific tokenizer, and a controlled decoding algorithm constitutes a technical solution that is tailored to long-form presentation generation. The model is trained with industrial-domain data and is configured to use performance indicators as explicit input tokens. The training process includes selection of an error function, a learning rate schedule, and a regularization method to accommodate long-context sequences and structured outputs. This configuration differs from generic text generation and brings about improved accuracy and stability for technical presentations related to industrial processes.

The server further implements non-conventional control logic in which the server uses internal rules and learned patterns to reweight sections of the presentation according to the user's inferred emotional state. This is not merely a display preference change; rather, it constitutes a dynamic reconfiguration of the data flow and layout order in the presentation pipeline, which leads to reduced latency for delivering critical information and a lower probability that the user overlooks important recommendations. The causal relationship between the emotional-state-based adjustments and the technical effects (faster access to key information, lower interaction steps, and reduced network transfers of unnecessary slides) is thereby established.

In another embodiment, the server can employ a different neural network architecture, such as a recurrent network with attention layers, or a smaller transformer variant deployed on a resource-constrained edge device. The terminal may be a stationary industrial console, a mobile device operated by a supervisor on the factory floor, or a head-mounted display system. The server may also interface with external control systems such that the generated improvement plans are not only displayed but also used to adjust machine control parameters after human approval, for example by generating machine-readable configuration files. This variation demonstrates that the generative AI model and the prompt sentence construction can be integrated into broader technical workflows that influence real-world equipment operation.

In a further embodiment, the server may store multiple templates for prompt sentence construction and select a template depending on industrial sector, data availability, or user preference. The server may also adjust internal hyperparameters of the generative AI model, such as a decoding temperature or a beam width, based on characteristics of the analysis data, to balance determinism and creativity in the generated presentation-material candidate text. These variations further illustrate how the server controls and optimizes internal computational processes in a technical manner, beyond simple automation of human drafting tasks.

Through these embodiments, the server, the terminal, and the generative AI model cooperate via a defined data structure and algorithmic sequence to transform raw industrial data and user input into structured, indicator-based prompt sentences, and to generate, organize, and adapt presentation materials. This configuration provides concrete technical improvements in processing efficiency, data quality, model output accuracy, and presentation adaptability, thereby enabling others skilled in the art to implement and use the invention in various computing environments.

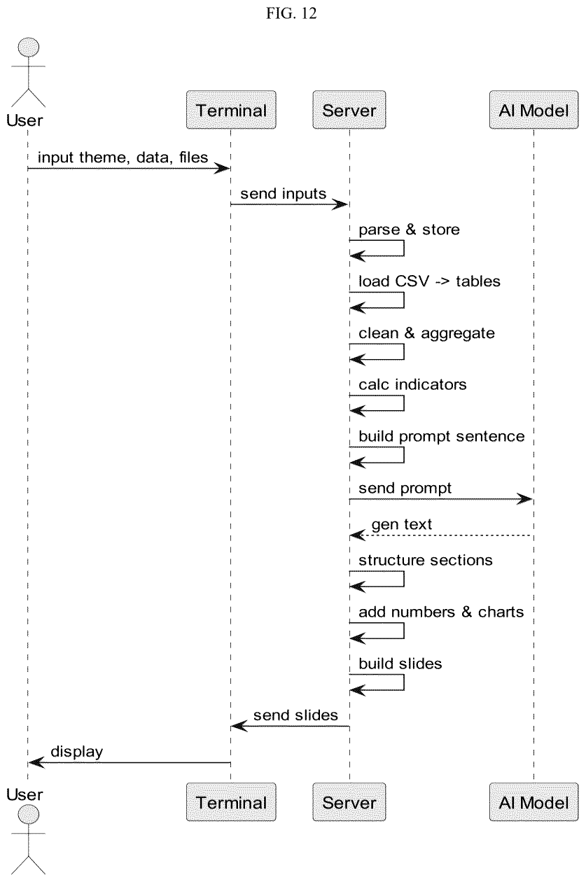

The following describes the processing flow using FIG. 12.

### Step 1:

The terminal displays an input screen including a text box for a presentation theme, numeric fields for quantitative information, a text area for qualitative information, and a file upload area for structured information files.

The user inputs, as an input to this step, a presentation theme and purpose, quantitative information such as target production volume and acceptable defect rate, qualitative information such as observed issues and operator feedback, and selects structured information files containing work performance information and quality evaluation information.

The terminal packages these inputs into a network request and sends, as an output of this step, a message containing the textual fields and one or more structured information files to the server via a communication network.

### Step 2:

The server receives, as an input to this step, the message containing the presentation theme and purpose, the quantitative information, the qualitative information, and the structured information files.

The server parses the message, separates the textual fields from the file payloads, and validates the content by checking required fields and data formats.

The server stores the validated textual fields in a database as records associated with a session identifier, and saves the structured information files in a file storage area, thereby outputting persistent session data and file references for later processing.

### Step 3:

The server reads, as an input to this step, the structured information files associated with the session, which include industrial work performance information and quality evaluation information.

The server loads the file contents into in-memory tabular data structures, converting delimited text into rows and columns representing timestamps, production quantities, defect counts, equipment identifiers, and other attributes.

The server outputs, from this step, one or more tabular data structures that represent the raw industrial data in a machine-processable form.

### Step 4:

The server takes, as an input to this step, the raw tabular data structures created in the previous step.

The server performs missing-value processing by scanning each relevant column, detecting empty or invalid entries, and imputing replacement values using rules such as mean, median, or last-observation-carried-forward, thereby transforming incomplete records into consistent records.

The server performs outlier processing by computing statistical descriptors for numerical columns, identifying values that exceed predefined thresholds, and capping or excluding those values according to configured rules.

The server outputs, from this step, cleansed tabular data structures in which missing values and outliers have been handled in a standardized way.

### Step 5:

The server receives, as an input to this step, the cleansed tabular data structures containing industrial work performance information and quality evaluation information.

The server performs aggregation processing by grouping records along dimensions such as time intervals, product categories, and equipment units, and computing aggregated metrics such as total production quantity per day, average defect rate per product, and downtime counts per shift.

The server performs index-calculation processing by applying formulas to the aggregated metrics to calculate performance indicators including a production-efficiency indicator, a defect-rate indicator, and an operation-status indicator.

The server outputs, from this step, analysis data that includes aggregated tables and numeric performance indicators ready for use in further computation.

### Step 6:

The server reads, as an input to this step, the stored presentation theme and purpose, the quantitative information, the qualitative information from the database, and the analysis data including the performance indicators from the previous step.

The server generates textual summary information by formatting the numeric performance indicators into natural-language sentences, such as summaries of average production volume, current defect rate, and typical downtime intervals.

The server integrates the theme, the quantitative information, the qualitative information, the performance indicators, and the textual summaries into a unified internal data structure that associates numeric fields with corresponding textual descriptions.

The server outputs, from this step, an integrated data structure that combines user-provided information and machine-calculated indicators.

### Step 7:

The server receives, as an input to this step, the integrated data structure that contains the theme, quantitative and qualitative information, performance indicators, and textual summaries.

The server constructs a prompt sentence by concatenating these elements into a structured, machine-readable text sequence, inserting section labels and explicit instructions for generating sections such as “Current Situation,” “Main Issues,” and “Improvement Proposals.”

The server outputs, from this step, a prompt sentence that encodes both user intent and processed industrial data, and that is ready to be provided to the generative AI model.

### Step 8:

The server takes, as an input to this step, the constructed prompt sentence.

The server applies a tokenizer linked to the generative AI model to convert character strings into token identifiers, forming a sequence suitable for neural network input.

The server forms an input tensor from the token sequence, applying padding or truncation based on a maximum sequence length configuration, and outputs an input tensor representing the prompt sentence in a numerical format.

### Step 9:

The server receives, as an input to this step, the numerical input tensor representing the tokenized prompt sentence.

The server executes the generative AI model, which in one embodiment is a transformer-based neural network with multiple attention layers, by feeding the input tensor through the model's layers, performing matrix multiplications, attention weight computations, and non-linear activations according to stored model parameters.

The server performs a decoding procedure, such as beam search or top-k sampling, to select output tokens step by step based on the model's probability distribution, until an end-of-sequence condition is reached.

The server decodes the output tokens into a character string, thereby outputting presentation-material candidate text containing narrative descriptions, performance interpretations, and improvement plans.

### Step 10:

The server takes, as an input to this step, the presentation-material candidate text generated by the generative AI model.

The server parses the text to detect headings, list markers, and paragraph breaks, using heuristic rules or explicit markers requested in the prompt sentence.

The server segments the text into display units, classifying each segment as a heading section, an explanatory section, or a list section, and builds a structured representation in which each display unit is a record with a type, title, and content fields.

The server outputs, from this step, a structured presentation text model that organizes the candidate text into discrete, renderable units.

### Step 11:

The server receives, as an input to this step, the structured presentation text model and the analysis data including numeric performance indicators.

The server associates specific numeric values and computed indicators with relevant display units, such as linking a production-efficiency indicator to a “Current Production Efficiency” section and linking a defect-rate trend to a “Quality Issues” section.

The server outputs, from this step, an enriched presentation structure in which each display unit is augmented with linked numeric information.

### Step 12:

The server takes, as an input to this step, the enriched presentation structure and the analysis data tables.

The server generates visualization information by creating charts and graphs for selected indicators, for example, line charts for production trends and bar charts for defect categories, using a charting library operating on the analysis data.

The server compresses or encodes the generated charts into image files or vector graphics and associates references to these visualizations with corresponding display units in the presentation structure.

The server outputs, from this step, a presentation structure that includes text, numeric indicators, and visualization references.

### Step 13:

The server receives, as an input to this step, the presentation structure including text, numeric indicators, and visualization references.

The server applies a layout template to construct a document for visual presentation, arranging display units into pages or slides, and assigning fonts, colors, and positions according to predefined style rules.

The server renders an output document, such as an HTML-based slide deck or a structured presentation document, that can be transmitted over the network and displayed on the terminal.

The server outputs, from this step, a complete visual presentation document ready for delivery.

### Step 14:

The server takes, as an input to this step, signals related to user interactions with the presentation, such as slide navigation speed, pauses, and explicit feedback entered via the terminal.

The server infers an emotional state of the user based on these interaction patterns by applying predefined rules, for example interpreting rapid skipping behavior as a sign of stress or overload.

The server adjusts the internal ordering of display units, the number of items per slide, and the level of textual detail in the presentation document in response to the inferred emotional state, for example by moving key summary slides earlier or collapsing low-priority details into optional sections.

The server outputs, from this step, an adapted version of the presentation document in which the presentation order, information amount, and expression format are tuned according to the user's emotional state.

### Step 15:

The server transmits, as an input to this step at the terminal side, the adapted presentation document and any associated visualization assets over the communication network.

The terminal receives the document, parses its structure, and renders the slides or pages on the display device, converting embedded references into visible charts and text.

The user views the generated presentation, navigates between display units using the terminal's input device, and may provide additional feedback or request regeneration, which becomes output from the terminal and serves as new input to the server for iteration or refinement.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional presentation authoring tools require a human creator to manually translate raw quantitative data and qualitative context into appropriate data visualizations, slide layouts, and narrative text. Even when a generative AI model is available, the construction of an effective prompt sentence, the selection of suitable visualization types, the control of document style, and the adaptation of content to a user's emotional state are typically performed in an ad hoc and non-systematic manner. As a result, the generation process is highly dependent on the user's expertise, is time-consuming, and often yields inconsistent quality.

Furthermore, known systems generally treat natural language content generation and data visualization as separate tasks. They do not tightly integrate structured data analysis, natural language analysis, prompt generation, generative AI inference, and slide-level assembly into a unified processing pipeline. In particular, such systems fail to automatically infer, from heterogeneous user inputs, (i) a set of candidate data representation methods, (ii) a visualization specification aligned with the presentation objective and audience, and (iii) a document format specification that reflects presentation environment information, such as formality or audience type.

Additionally, existing approaches do not provide a mechanism by which the system learns, over time, how to better construct prompt sentences and choose visualization methods based on user feedback. They also lack fine-grained control for post-processing AI-generated text so that it conforms to predetermined length and style constraints, and they do not systematically adjust both textual expressions and visual formatting based on detected or provided user emotion state information. This limits the ability of the system to produce presentations that are both technically accurate and emotionally aligned with the user's needs.

Accordingly, there is a need for an improved computer-implemented technique that (1) programmatically analyzes both structured quantitative information and unstructured qualitative information, (2) automatically determines and materializes appropriate data visualization and document formatting specifications, (3) generates and manages prompt sentences for a generative AI model in a structured and controllable manner, (4) assembles an electronic presentation document from AI-generated text and system-generated visualization images, and (5) adaptively refines prompt-generation rules and visualization decision rules using user feedback and emotion state information. Such a technique should improve the functioning of the computer system itself by automating complex configuration steps that are conventionally performed by humans, and by providing a feedback loop that continuously optimizes the generation process.

The specific processing by the specific processing unit 290 of the data processing device 12 in Example 2 is realized by the following means.

The present invention provides a server comprising a processor and a memory storing instructions which, when executed by the processor, cause the processor to receive, from a user, presentation information including a theme, an objective, a target audience, environment information, quantitative information, and qualitative information; analyze structured information included in the quantitative information to extract a data type, time information, classification information, and measurement values, and determine candidate data representation methods corresponding to the structured information; analyze natural language information included in the qualitative information to extract keywords, important phrases, and a presentation type, and determine structural elements and a logical structure of a presentation material; automatically determine a visualization specification including a graph type, axis items, aggregation methods, and a layout based on the candidate data representation methods and the structural elements of the presentation material, and generate data visualization images in accordance with the visualization specification; automatically determine a document format specification including a color scheme, a font, a font size, and a background style based on the environment information and the target audience; generate a prompt sentence including the theme, the objective, the target audience, the structural elements of the presentation material, the visualization specification, and the document format specification, input the prompt sentence to a generative AI model, and obtain text information including a section structure of the presentation material, slide titles, and bullet-point contents; format the text information to satisfy a predetermined length and style, and combine the formatted text information with the data visualization images and the document format specification to automatically generate the presentation material as an electronic presentation document; adjust at least one of expressions in the text information and the document format specification based on emotion state information of the user; generate a plurality of kinds of the data visualization images and input to the generative AI model a prompt sentence including the plurality of kinds of the data visualization images and candidate explanatory texts corresponding thereto; select, on a slide-by-slide basis and based on a response from the generative AI model, a data representation method and an explanatory text to be used so as to optimize a structure of the presentation material; and store the prompt sentence and the text information obtained from the generative AI model in association with evaluation information or feedback information received from the user, and update generation rules for the prompt sentence and decision rules for the data representation methods based on a storage result so as to adaptively improve subsequent presentation material generation processing. This enables a computer system to automatically transform heterogeneous presentation inputs into optimized electronic presentation documents through integrated data analysis, AI-assisted content generation, visualization control, style control, and feedback-driven adaptation, thereby improving the technical efficiency, consistency, and adaptability of computer-based presentation generation.

The term “presentation information” refers to information provided by a user for generation of a presentation material, including at least a theme, an objective, a target audience, environment information, quantitative information, and qualitative information.

The term “theme” refers to a main subject or topic of a presentation material, expressed as natural language text.

The term “objective” refers to a purpose or intended outcome of a presentation, including at least one of informing, persuading, reporting, or proposing.

The term “target audience” refers to a group of intended recipients of a presentation, characterized by attributes such as expertise level, role, or affiliation.

The term “environment information” refers to contextual information regarding circumstances of a presentation, including at least one of a venue type, a formality level, a presentation format, or an event type.

The term “quantitative information” refers to information including numeric values suitable for computation, such as counts, amounts, measurements, or time-series data.

The term “qualitative information” refers to non-numeric information expressed in natural language or categorical form, including descriptions of entities, conditions, preferences, or narrative context.

The term “structured information” refers to information organized in a predefined format, such as tabular data, in which attributes are represented as fields or columns with associated data types.

The term “data type” refers to a classification of data values, including at least one of numeric, categorical, temporal, or textual types.

The term “time information” refers to temporal attributes of data, including at least one of a date, a time, a time period, or a time interval.

The term “classification information” refers to information that assigns data items to discrete groups or categories, such as regions, product types, or user segments.

The term “measurement values” refers to numeric values representing measurable quantities, such as sales amounts, counts of units, or performance metrics.

The term “candidate data representation methods” refers to potential ways of visually representing data, including at least one of a line graph, a bar graph, a pie chart, a table, or a scatter plot.

The term “natural language information” refers to information expressed using human language text, including sentences, phrases, or keywords.

The term “keywords” refers to salient words or terms extracted from natural language information that represent main concepts or topics.

The term “important phrases” refers to multi-word expressions extracted from natural language information that collectively convey significant semantic meaning or intent.

The term “presentation type” refers to a classification of a presentation according to its purpose or genre, including at least one of a performance report, a market analysis, a project proposal, or an educational explanation.

The term “structural elements of a presentation material” refers to logical components of a presentation, including at least one of sections, subsections, slides, slide titles, and bullet-point groups.

The term “logical structure of a presentation material” refers to an arrangement and ordering of structural elements that defines a flow of information in a presentation.

The term “visualization specification” refers to a set of parameters defining a visual representation of data, including at least a graph type, axis items, aggregation methods, and layout information.

The term “graph type” refers to a category of visualization for representing data, including at least one of a line graph, a bar graph, a pie chart, a scatter plot, or a stacked bar graph.

The term “axis items” refers to data attributes or dimensions assigned to axes or equivalent positional encodings in a visualization, such as horizontal and vertical axes.

The term “aggregation methods” refers to computational operations used to summarize data, including at least one of summation, averaging, counting, minimum, maximum, or grouping.

The term “layout” refers to a spatial arrangement of visual or textual elements within a visualization or a slide, including positions, sizes, and relative alignment.

The term “data visualization images” refers to electronic image data generated according to a visualization specification and representing one or more aspects of structured information.

The term “document format specification” refers to a set of parameters defining visual appearance of a presentation material, including at least a color scheme, a font, a font size, and a background style.

The term “color scheme” refers to a selection and combination of colors used for elements of a presentation material, such as backgrounds, texts, and graphical accents.

The term “font” refers to a typeface used for displaying textual content, including style attributes such as family and weight.

The term “font size” refers to a measure of the size of textual characters displayed in a presentation material.

The term “background style” refers to a visual configuration of a slide or page background, including at least one of a solid color, a gradient, an image, or a pattern.

The term “prompt sentence” refers to a machine-readable instruction text constructed for input to a generative AI model, the text including contextual information and constraints for generating or modifying content.

The term “generative AI model” refers to a machine learning model configured to generate text or other content in response to input data, including at least a large language model.

The term “text information” refers to content generated by the generative AI model or by the system, including at least a section structure, slide titles, and bullet-point contents for a presentation material.

The term “section structure” refers to an organized set of sections and subsections defining a high-level outline of a presentation material.

The term “slide titles” refers to textual labels assigned to individual slides that summarize or identify a main topic of each slide.

The term “bullet-point contents” refers to a set of text items presented as discrete, typically short, points listed on a slide.

The term “predetermined length” refers to a constraint defining an upper or lower bound of textual size, such as a maximum number of words, characters, or bullet points.

The term “style” refers to one or more textual properties such as tone, formality level, or grammatical structure applied to generated text.

The term “electronic presentation document” refers to digital data representing a multi-page or multi-slide presentation, suitable for display by presentation software.

The term “emotion state information” refers to information indicative of a user's emotional condition, including at least one of stress level, satisfaction level, or preference for tone, obtained explicitly from user input or implicitly from analysis.

The term “data visualization images of a plurality of kinds” refers to multiple data visualization images that differ from each other in at least one of graph type, axis configuration, aggregation method, or layout.

The term “candidate explanatory texts” refers to alternative textual descriptions generated or prepared as potential explanations for respective data visualization images.

The term “slide-by-slide basis” refers to processing in which a selection or operation is performed independently for each slide of a presentation material.

The term “evaluation information” refers to information indicating a user's assessment of generated content, including at least one of ratings, selection choices, or qualitative comments.

The term “feedback information” refers to information provided by a user to modify or critique generated content, including requests for change, corrections, or improvement suggestions.

The term “generation rules for the prompt sentence” refers to parameters or procedures used by the system to construct a prompt sentence, including selection, ordering, and formatting of elements included in the prompt sentence.

The term “decision rules for the data representation methods” refers to parameters or procedures used by the system to select a data representation method based on characteristics of structured information and qualitative context.

In one embodiment, a server cooperates with one or more terminals operated by a user to generate electronic presentation documents. The server includes at least one processor, a main memory, a non-transitory storage device, and a network interface. The terminal includes an input unit, a display unit, and a communication unit. The processor of the server executes a presentation-generation program stored in the storage device. The presentation-generation program is implemented, for example, as an application running on an operating system such as a general-purpose server operating system, and uses a scripting runtime such as a Python runtime environment together with numerical computation libraries and natural language processing libraries.

The terminal displays an input user interface that allows the user to provide presentation information. The user operates the terminal to input a presentation theme, an objective, a target audience, environment information, and qualitative descriptions in natural language via text input fields. The user further operates the terminal to upload files containing quantitative information, such as tabular data in a comma-separated-value format or spreadsheet format. The terminal transmits the collected presentation information to the server through the communication unit using a network protocol such as HTTPS.

The server receives the presentation information through the network interface and stores it in a structured data store. The server uses a database management system, such as a relational database, to store metadata describing the theme, objective, target audience, environment information, and file paths of the uploaded quantitative information. The server also uses a file system or an object storage system to store the raw files of the quantitative information. The server associates each received presentation information set with a job identifier, which the server returns to the terminal so that the terminal can later request the generated presentation document.

The server parses the quantitative information using a data processing module that is configured to utilize a data frame library. The server loads tabular data from the quantitative information into data frame objects, inspects column names and inferred data types, and normalizes the data into a standard internal representation. For example, the server converts date strings into time-stamp objects, converts numeric strings into floating-point numbers, and encodes categorical values as integer indices. The server detects time-series columns by examining value distributions and regular patterns, and detects measures, such as sales amounts or counts of units, by checking numeric ranges and metadata. The server thereby generates structured information that includes explicit data type annotations, time information, classification information, and measurement values.

The server analyzes the qualitative information using a natural language processing module that is configured to execute tokenization, part-of-speech tagging, and dependency parsing. The server can use an NLP library such as a general natural language toolkit to implement these functions. The server executes a keyword extraction algorithm that computes term-importance scores, for example by a term-frequency-inverse-document-frequency measure or by an attention-weight-based measure from a contextual embedding model. The server identifies important phrases based on syntactic patterns, such as noun phrases and verb-object constructions, and generates candidate phrases representing the theme and objective. The server further applies a text classification model that has been trained to assign a presentation type label, such as “performance report,” “market analysis,” or “project proposal,” based on contextual embeddings of the theme and objective sentences.

The server implements the text classification model as a neural network that receives token embeddings generated by a transformer encoder. The transformer encoder includes multiple self-attention layers and feed-forward layers. The server trains the model offline using supervised learning with labeled training data. During training, the server uses a cross-entropy loss function to measure classification error, and updates model weights using a gradient-based optimization algorithm such as an adaptive moment estimation method. The server applies regularization, mini-batch training, and learning-rate scheduling to improve generalization and convergence speed. As a result, during inference, the classification model efficiently computes a presentation type from the qualitative information with high accuracy.

The server determines candidate data representation methods by combining the structured information and the qualitative analysis results. The server maintains rule sets in the storage device that map combinations of data characteristics and presentation types to visualization types. For example, when the server detects a time-series measure associated with multiple categories, and the presentation type is determined to be a “performance report,” the server selects a line graph as a primary candidate visualization and a stacked bar graph as a secondary candidate. The server uses a rule-based inference engine that evaluates conditions on data type, cardinality, presence of time information, and number of comparison categories. The server stores candidate data representation methods in a visualization specification data structure that includes a graph type, axis assignments, aggregation methods, and layout hints.

The server generates data visualization images using a plotting engine executed in the server's runtime environment. The server uses a charting library, such as a generic plotting library, to instantiate figure objects, assign axis items to horizontal and vertical axes, and apply aggregation methods such as summation of measurement values across time bins or grouping by categorical labels. The server configures visual properties of each visualization, including color palette, line thickness, marker shape, and legend positioning, according to the visualization specification and the environment information. For example, when the environment information indicates a formal setting, the server chooses a restricted set of muted colors and thinner grid lines to improve readability. The server rasterizes the visualization into image files, such as PNG files, and stores file paths in association with chart identifiers.

The server determines a document format specification that controls the appearance of the generated presentation document. The server uses the environment information and the target audience attributes stored in the database to select a design profile from a library of predefined style templates. Each design profile specifies a color scheme, font families, font sizes for titles and body text, and background styles for different slide types. The server implements these profiles as configuration objects stored in a style repository. For instance, a “formal executive” profile may specify a white background, a dark primary accent color, a sans-serif font for body text, and a serif font for titles. The server can also adapt the document format specification by modifying font sizes and contrast levels to account for accessibility preferences indicated by the user.

The server generates a prompt sentence for a generative AI model based on the theme, objective, target audience, structural elements of the presentation material, visualization specification, and document format specification. The server constructs the prompt sentence as a structured natural language instruction. The server concatenates description segments for the presentation context, enumerates planned sections and slide types, and describes each selected visualization, including its purpose and data fields. An example of such a prompt sentence is:

“You are preparing slides for a formal business presentation on ‘Market analysis for the new product X in Q1 2026’. The objective is to brief executive board members. The target audience consists of senior executives with limited time. The presentation includes: (1) an introduction to the product and market context, (2) a line chart of monthly sales for Q1 2026, (3) a bar chart comparing regional sales performance, and (4) a slide with key insights and strategic recommendations. Use a concise, formal, and data-driven tone. Propose slide titles and bullet-point contents for each section, and align explanations with the provided visualizations.”

The server transmits the prompt sentence to the generative AI model using an application programming interface. In one embodiment, the server uses a large language model configured as a transformer-based neural network. The generative AI model receives a tokenized representation of the prompt sentence and computes, layer by layer, attention-weighted representations of the tokens. The model outputs a sequence of tokens representing text information such as section headings, slide titles, and bullet-point contents. The server configures decoding parameters such as temperature and maximum token length to control diversity and length of generated text. The server executes these operations on hardware resources such as graphics processing units or accelerators to achieve low-latency generation.

The server post-processes the text information received from the generative AI model. The server applies a formatting module implemented as a rule-based system and, optionally, an additional language model that has been fine-tuned for style normalization. The server segments the generated text into per-slide content blocks, enforces predetermined length constraints by truncating or summarizing overly long bullet points, and adjusts tone markers to match a desired formality level. The server removes redundant phrases and unneeded preambles by detecting repeated subsequences through string-similarity metrics. The server then combines the processed text information with the visualization images and the document format specification to instantiate a presentation document file.

The server uses a document-generation library to create an electronic presentation document. The server instantiates a new presentation object, applies the selected design profile to the slide master, and programmatically adds slides corresponding to each structural element. The server inserts the slide titles and bullet-point contents into text placeholders defined in the slide layouts. The server places each visualization image at predefined regions on the slides, adjusting size and aspect ratio to avoid overlap with text. The server aligns text and images to grid positions to ensure consistent appearance across slides. The server finally writes the presentation object to a file format, such as a slide-based presentation file, and stores the generated file in persistent storage. The server returns to the terminal a reference, such as a URL, that allows the user to download or open the generated file.

The server can generate multiple variants of data visualization images for the same underlying structured information. For example, the server may generate both a line graph and a bar graph for a given time-series measure. The server constructs a second prompt sentence that describes these variants and requests recommendations regarding which visualization should be used for which slide and how it should be explained. An example of this prompt sentence is:

“For the slide on Q1 2026 sales trends, two visualization options are available: (1) a line chart showing monthly sales from January to March; (2) a bar chart showing the same monthly sales. For a formal executive board presentation, select the more effective visualization and provide a concise explanation that highlights key trends and supports decision-making. Also provide a one-sentence justification for your choice of visualization.”

The server inputs this prompt sentence to the generative AI model and receives a response containing recommended visualization selection and explanatory text. The server parses the response to determine, for each slide, which data representation method is preferred and which explanatory text to use. The server thereby optimizes the structure and content of the presentation by leveraging the generative AI model in a controlled, slide-by-slide manner, rather than relying solely on static rules.

The server adjusts the text information and the document format specification based on emotion state information of the user. The terminal may provide an interface that allows the user to indicate an emotion label, such as “anxious,” “confident,” or “neutral,” or to select a desired emotional tone for the presentation. In an alternative embodiment, the server derives emotion state information from interaction logs or from sentiment analysis of user-provided comments. The server uses rule sets that map emotion states to modifications of textual style and visual appearance. For example, when the user indicates a high level of anxiety, the server may increase the amount of reassuring explanation in the introduction slides, simplify technical language in conclusions, and select a calmer color scheme. These adjustments are applied deterministically according to predefined thresholds so that the resulting presentation is both emotionally aligned and structurally consistent.

The server stores the prompt sentences and corresponding responses from the generative AI model, together with evaluation information and feedback information received from the user. The server maintains a feedback database that records, for each presentation generation job, the prompt content, the visualization specification used, the generated text information, and rating or comments provided by the user through the terminal. The server uses this feedback database to update internal generation rules. For example, the server can train a secondary model that predicts user satisfaction scores based on features extracted from the prompt and the generated content, and then modifies rule weights used in visualization selection. The server can also adjust templates for prompt sentence construction by emphasizing or de-emphasizing certain elements, such as adding explicit length constraints when prior user feedback indicates that generated slides tend to be too verbose.

The server improves computer performance in several ways. First, by analyzing structured information to infer data types and relationships before visualization, the server reduces redundant rendering passes and avoids trial-and-error chart generation that would otherwise occur. This reduces computation time and memory usage. Second, by constructing prompt sentences according to a standardized template that includes explicit constraints and references to visualization specifications, the server reduces the number of generative AI model calls required to obtain satisfactory output, thereby lowering network traffic and model-inference cost. Third, by caching intermediate representations and by selecting visualizations according to pre-computed decision rules and learned preferences, the server reduces overall latency of presentation generation for repeated presentation types. These technical improvements are realized through specific data structures, such as typed data frames, visualization specification objects, style configuration objects, and feedback records, and through the interaction of these structures within the processing pipeline.

The server uses a neural network architecture for the generative AI model that is configured to handle long-context instructions and structural hints. The server trains the model or utilizes a pre-trained model that includes multiple encoder-decoder layers with self-attention and cross-attention mechanisms. During training, the server uses a maximum-likelihood objective combined with auxiliary losses, such as a coverage loss to reduce repetition and a style-consistency loss computed using a separate style classifier. The server performs weight updates using stochastic gradient descent or a variant thereof, and applies data augmentation techniques such as paraphrasing and sentence shuffling to expose the model to diverse instruction patterns. This configuration enables the generative AI model to respond more accurately and consistently to structured prompt sentences, which in turn allows the server to control the content generation process with fewer post-processing corrections.

The server, by combining rule-based components, numerical computation components, and neural-network-based components, executes a non-conventional sequence of operations that is not merely a direct automation of human slide authoring. For example, the server uses machine-detectable characteristics of the structured information to decide visualization candidates, rather than relying on a user's visual intuition. The server uses learned mappings from qualitative descriptions to presentation types to enforce consistent document structures across similar jobs. The server uses system-level feedback loops to adapt prompt construction and visualization selection rules over time based on objective and subjective evaluations recorded in the feedback database. These features collectively yield measurable improvements in generation consistency, reduction of user correction time, and reduction of computational overhead compared to naive automation of presentation drafting.

In other embodiments, the server can integrate with external presentation platforms to control display devices. For instance, the server can transmit the generated electronic presentation document to a projection system or to a conference room display controller via a local network. The server can dynamically update the presentation document in response to real-time feedback or changes in structured information, such as updated sales figures, by selectively regenerating only affected slides. This incremental update mechanism reduces data transfer volume and re-rendering cost, further improving system efficiency.

In an alternative implementation, the server can use different machine learning architectures, such as recurrent neural networks or convolutional sequence models, for certain sub-tasks like keyword extraction or sentiment analysis, while maintaining the same overall data flow. The server can also support different file formats for the electronic presentation document, including slide-based formats, portable document formats, or web-based interactive formats. In each variant, the server maintains the core functionality of analyzing heterogeneous presentation information, determining visualization and format specifications, generating and managing structured prompt sentences for a generative AI model, integrating AI-generated text with system-generated visualizations, and adaptively improving these processes based on user feedback and emotion state information.

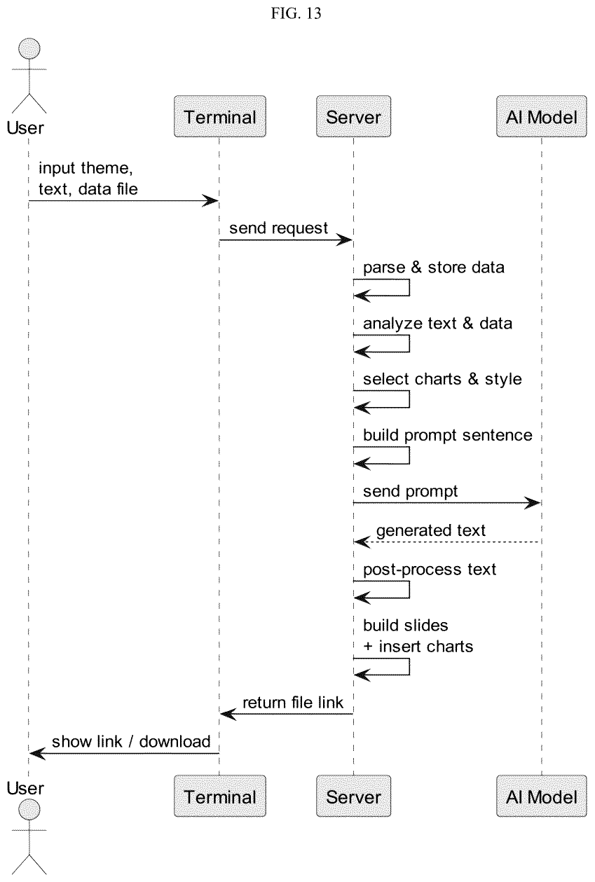

The following describes the processing flow using FIG. 13.

### Step 1:

The terminal displays an input screen, and the user inputs presentation information including a theme, an objective, a target audience, environment information, and qualitative descriptions, and uploads one or more data files containing quantitative information. The terminal takes, as input, user keystrokes and file selections, validates file formats and sizes, and outputs a structured request payload including text fields and binary file data.

### Step 2:

The terminal transmits the structured request payload to the server via a network. The terminal takes, as input, the validated presentation information and file contents, serializes the information into a request message (for example, an HTTPS POST), and outputs the message to the server through a communication interface.

### Step 3:

The server receives the request message and stores the raw data in internal storage. The server takes, as input, the serialized payload, parses header and body data, writes the uploaded files to a file system or object storage, stores metadata in a database (including file paths, user ID, and timestamps), generates a job identifier, and outputs the job identifier and stored records as initial internal state.

### Step 4:

The server loads the quantitative information into a structured data representation. The server takes, as input, the stored file paths, reads tabular content using a data-frame library, infers column data types by examining value patterns and metadata, converts date strings to time-stamp objects, converts numeric strings to numeric types, encodes categorical values as indices, and outputs a structured information object that includes data types, time information, classification information, and measurement values.

### Step 5:

The server analyzes the qualitative information to extract semantic features. The server takes, as input, the theme, objective, target audience description, and other natural language text, tokenizes the text, applies part-of-speech tagging and dependency parsing, calculates term-importance scores, segments text into candidate phrases, and outputs sets of keywords, important phrases, and contextual features.

### Step 6:

The server classifies the presentation type using a trained neural network model. The server takes, as input, the tokenized text and contextual features, converts tokens into embeddings, propagates the embeddings through multiple attention and feed-forward layers of a transformer-based classifier, computes class probabilities using a softmax layer, selects the label with the highest probability (for example, “market analysis” or “performance report”), and outputs a presentation type label together with confidence scores.

### Step 7:

The server determines candidate data representation methods using a rule-based visualization engine. The server takes, as input, the structured information and the presentation type label, evaluates rule conditions over attributes such as presence of time information, number of categories, and numeric ranges, matches these attributes against a rule set that maps conditions to visualization types, selects one or more candidate graph types (for example, line graph, bar graph, scatter plot), and outputs a list of candidate data representation methods associated with specific data subsets.

### Step 8:

The server builds a visualization specification for each selected data representation method. The server takes, as input, the candidate visualization methods and the structured information, selects axis items (for example, time on the horizontal axis and measurement values on the vertical axis), chooses aggregation methods (for example, summation by month or averaging by category), determines layout parameters (such as chart size and legend position), and outputs a visualization specification object that encodes graph type, axis configuration, aggregation logic, and layout hints.

### Step 9:

The server generates data visualization images based on the visualization specification. The server takes, as input, the visualization specification and the underlying structured information, performs aggregations using numerical operations (such as grouping and summing in the data-frame library), instantiates figure objects in a plotting library, applies styles such as color palettes and line thickness according to environment information, renders charts as raster images (for example, PNG files), and outputs file paths and identifiers for each data visualization image.

### Step 10:

The server determines a document format specification according to the environment information and target audience. The server takes, as input, environment attributes (for example, formality level, venue type) and audience attributes (for example, expertise level), selects a style profile from a library of profiles, adjusts parameters such as font family, font size, color scheme, and background style, composes these into a document format specification object, and outputs the selected specification as configuration data for later slide generation.

### Step 11:

The server derives structural elements and a logical outline of the presentation material. The server takes, as input, the theme, objective, presentation type label, keywords, and important phrases, applies outline-generation rules that map presentation types to typical section patterns, assigns major topics to sections (for example, “Introduction,” “Data Overview,” “Key Findings,” “Recommendations”), associates relevant visualizations with appropriate sections, and outputs an outline structure describing sections, slides, and their relationships.

### Step 12:

The server constructs a prompt sentence for a generative AI model. The server takes, as input, the outline structure, theme, objective, target audience description, visualization specification, and document format specification, concatenates these elements into a structured natural language instruction, inserts explicit constraints on tone, length, and style, and outputs a complete prompt sentence. For example, the server produces text such as: “You are preparing slides for a formal business presentation on ‘Market analysis for the new product X in Q1 2026’ . . . Propose slide titles and bullet-point contents for each section, and align explanations with the provided visualizations.”

### Step 13:

The server transmits the prompt sentence to the generative AI model and obtains generated text information. The server takes, as input, the prompt sentence, tokenizes it, sends the tokens to a transformer-based generative model via an API call, receives a sequence of output tokens representing generated text, decodes the tokens into natural language strings, segments the response into slide-level blocks, and outputs preliminary text information including section headings, slide titles, and bullet-point contents.

### Step 14:

The server post-processes the generated text information to satisfy length and style constraints. The server takes, as input, the preliminary text information and predefined constraints (such as maximum number of bullet points per slide), applies rules to truncate or summarize long sentences, modifies vocabulary to match the required formality level, removes repeated or irrelevant sentences detected via similarity measures, and outputs cleaned and formatted text information for each slide.

### Step 15:

The server adjusts the text information and document format specification based on emotion state information of the user. The server takes, as input, emotion state labels or scores provided by the user or inferred from interaction data, evaluates mapping rules that relate emotion states to stylistic changes, modifies sentence structures (for example, adding reassurances or simplifying complex phrases) and visual parameters (for example, choosing calmer colors), and outputs an updated set of slide texts and an updated document format specification aligned with the user's emotional state.

### Step 16:

The server generates multiple variants of data visualization images for optimization. The server takes, as input, the structured information and the existing visualization specification, creates alternative visualization specifications by varying graph types or aggregation granularity, regenerates multiple visualization images from the same data, stores their file paths, and outputs a set of visualization variants associated with each slide candidate.

### Step 17:

The server constructs an optimization prompt sentence for selecting visualization variants and explanatory texts. The server takes, as input, the visualization variants and preliminary explanatory text candidates, describes each variant and its intended purpose in natural language, embeds a request for selection and justification (for example, which chart better supports decision-making), and outputs a second prompt sentence tailored for comparative evaluation by the generative AI model.

### Step 18:

The server inputs the optimization prompt sentence to the generative AI model and selects slide-level visualization and explanations. The server takes, as input, the second prompt sentence, sends it to the generative AI model via an API, receives output text describing preferred visualizations and explanations, parses the response to identify which visualization variant is recommended for each slide and which explanatory paragraph to use, and outputs final assignments of data representation methods and corresponding explanatory texts.

### Step 19:

The server assembles the electronic presentation document using a document-generation library. The server takes, as input, the outline structure, cleaned slide texts, final visualization assignments, and the document format specification, creates a new presentation object, configures slide masters with the specified fonts, colors, and background styles, programmatically creates slides in the defined order, inserts slide titles and bullet-point texts into layout placeholders, embeds visualization images at pre-calculated positions, adjusts sizes to avoid overlap, and outputs a complete electronic presentation document file stored in persistent storage.

### Step 20:

The server generates feedback records and exposes the result to the terminal. The server takes, as input, the job identifier, the final presentation file path, the prompt sentences, and the generated text information, stores these elements together with metadata in a feedback database, sets a job status to “completed,” creates a download URL or file reference, and outputs a response message containing the reference and summary information to the terminal.

### Step 21:

The terminal receives the response and presents access to the generated presentation to the user. The terminal takes, as input, the server response message, extracts the download URL or file reference, updates the user interface to display a “Download” or “Open” control, and outputs a visual indication on the display so that the user can retrieve and review the generated presentation document.

### Step 22:

The user reviews the generated presentation and optionally provides evaluation or feedback information. The user takes, as input, the generated slides displayed by presentation software, inspects slide contents, visualization choices, and style, and operates the terminal to submit ratings, comments, or modification requests. The terminal collects this evaluation information and outputs a feedback request message to the server.

### Step 23:

The server receives the feedback request and updates internal rules or models. The server takes, as input, the evaluation information, links it with stored prompt sentences, visualization specifications, and generated texts via the job identifier, writes these associations into the feedback database, recalculates statistics or retrains auxiliary models that predict user satisfaction or recommend visualization choices, updates generation rules for prompt sentences and decision rules for data representation methods, and outputs updated configuration parameters that will be used in subsequent presentation generation jobs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented presentation generation systems typically rely on static templates and manual authoring workflows. In such systems, a processor generally accepts user input describing a topic and then populates pre-defined slide layouts with text and simple charts. These arrangements suffer from several technical limitations.

First, the processor is not configured to represent the user's intent as a structured task description, and therefore cannot automatically adapt the generation logic to different purposes, audiences, time constraints, or expression styles. As a result, the system often produces inappropriate information density, slide structure, or tone, which in turn requires extensive manual correction. This leads to inefficient use of processor and memory resources, because the system repeatedly renders and stores multiple draft versions that the user must edit manually.

Second, conventional systems treat quantitative information and qualitative information in isolation. A typical processor may render numerical values into a chart, but it does not automatically correlate these numerical values with a high-level narrative structure. As a result, the system cannot systematically select suitable visualization types or scales based on the data characteristics and the intended message. The processor therefore performs redundant computations on unsuitable visualizations, and the generated material frequently fails to highlight relevant trends or relationships in the data.

Third, existing systems do not incorporate real-time emotion information into the generation pipeline. A processor may ignore the emotional state of the user or audience entirely, and thus uses a fixed style and information density regardless of stress, confusion, excitement, or relaxation. Because the system does not dynamically adjust the prompt to a generative AI model, or the resulting visualization and layout, the processor repeatedly generates static content that does not match the user's cognitive load or engagement state. This mismatch can cause unnecessary re-generation and manual editing, wasting computational resources and network bandwidth.

Fourth, conventional systems that utilize generative AI models typically send a simple prompt sentence that lacks explicit task parameters and structured context. This often causes the generative AI model to produce outputs that are inconsistent with the user's constraints, such as the required number of slides, presentation duration, or target audience. In order to correct these deficiencies, the processor must perform additional post-processing or must request multiple generations from the model, which increases latency and processing load.

Accordingly, there is a need for an improved computer-implemented system that (i) transforms heterogeneous user inputs, including presentation themes, quantitative information, qualitative information, and user state information, into a structured task representation; (ii) generates and refines prompt sentences for a generative AI model in a processor-efficient way; (iii) automatically selects and generates data visualization elements aligned with the task representation; (iv) dynamically adjusts the prompt, generated content, and layout based on emotion information acquired during preparation and execution of a presentation; and (v) outputs presentation material data in a format that is immediately editable on a terminal device without requiring extensive manual rework. Such a system improves the operation of the computer itself by reducing redundant computations, lowering the number of generation cycles, and enabling adaptive control of content density and visualization at run time.

The specific processing by the specific processing unit 290 of the data processing device 12 in Application Example 2 is realized by the following means.

The present invention provides a server comprising a processor configured to receive, from a user, information including a presentation theme, quantitative information, and qualitative information, to analyze the information by performing natural language processing to extract task information indicating at least a purpose, a target audience, a time allocation, and an expression style for presentation material, to generate, based on the task information and the quantitative information, a prompt sentence in a natural language format to be input to a generative AI model, to input the prompt sentence to the generative AI model and obtain presentation material candidate information including at least a slide structure, text information, and specification of visual elements, to perform statistical processing and aggregation processing on the quantitative information to generate a data set associated with the presentation theme and the presentation material candidate information, to generate, based on the data set, data visualization elements including at least one of a graph, a table, and a figure, to generate presentation material data by determining, based on the presentation material candidate information and the data visualization elements, at least one of layout, font, color, and information density on a per-slide basis, to acquire user state information including at least facial information and voice information and calculate emotion information indicating an emotional state of the user based on the user state information, to dynamically adjust, according to the emotion information, at least one of a content of the prompt sentence, the data visualization elements, and the presentation material data, and to output the presentation material data in at least one of a slide file format and an electronic document format, transmit the presentation material data to a terminal device, and present the presentation material data in an editable form on the terminal device. This enables the computer system to automatically transform heterogeneous user inputs and real-time emotion information into structured task information, to control a generative AI model with context-rich prompt sentences, to generate and adapt data visualizations and slide layouts in a single integrated pipeline, and thereby to reduce redundant processing, improve utilization of computational and network resources, and provide presentation material that is better aligned with user constraints and cognitive state with reduced manual editing.

The term “processor” refers to a hardware or virtual information processing element, such as a central processing unit or a processing core, that executes program instructions to perform analysis, generation, and control operations described in the present specification.

The term “presentation theme” refers to information indicating a primary subject, topic, or concept to be addressed by presentation material, such as a title, main topic description, or central idea.

The term “quantitative information” refers to numerical information including at least time values, time-series numerical data, category-based numerical data, ratio data, and other values that can be processed by arithmetic and statistical operations.

The term “qualitative information” refers to non-numerical information including at least audience attribute information, environmental condition information, atmosphere information, tone information, and other descriptive characteristics that influence style or context of presentation material.

The term “natural language processing” refers to processing performed by a computer to analyze natural language text, including at least tokenization, part-of-speech tagging, entity extraction, and phrase extraction, in order to derive structured information from unstructured text.

The term “task information” refers to structured information derived from user input that specifies at least a purpose of a presentation, a target audience, a time allocation, and an expression style required for generation of presentation material.

The term “generative AI model” refers to a machine-implemented model trained to generate text or other content, which receives a prompt sentence as input and outputs presentation material candidate information including at least slide structures, textual content, and visual element specifications.

The term “prompt sentence” refers to a natural language instruction string provided to the generative AI model, the instruction string including at least task information and optionally data summaries and style constraints, and guiding the generative AI model to generate presentation material candidate information.

The term “presentation material candidate information” refers to intermediate structured data generated by the generative AI model, including at least definitions of slide structures, textual elements, section ordering, and designations of required visual elements.

The term “statistical processing” refers to computation performed on quantitative information, including at least aggregation, averaging, summation, calculation of ratios, and trend analysis, to derive a data set suitable for visualization and narrative integration.

The term “aggregation processing” refers to operations that combine multiple pieces of quantitative information into grouped or summarized values, such as totals per category or per time period.

The term “data set” refers to a structured collection of processed quantitative information associated with a presentation theme and presentation material candidate information, which is used for generating data visualization elements.

The term “data visualization element” refers to a visual representation derived from the data set, including at least one of a graph, a table, and a figure, and encoded in a format suitable for insertion into presentation material.

The term “graph” refers to a visual element that represents numerical relationships using axes and graphical marks, including at least line charts, bar charts, pie charts, and scatter plots.

The term “table” refers to a visual element that organizes numerical or categorical values into rows and columns with headers, for display within presentation material.

The term “figure” refers to any non-textual illustrative element other than a table, including at least diagrams, icons, schematics, and other graphical symbols.

The term “presentation material data” refers to digital data describing one or more slides or pages of a presentation, including at least text, layout parameters, and data visualization elements, and encoded in a machine-readable format.

The term “layout” refers to positional and structural arrangement information for elements on a slide or page, including at least placement of titles, text blocks, and data visualization elements.

The term “font” refers to attributes of textual rendering in presentation material, including at least typeface, size, weight, and style.

The term “color” refers to visual attributes assigned to text, backgrounds, and graphical elements, including hue, saturation, and brightness parameters.

The term “information density” refers to a measure of the amount and complexity of information presented per slide or page, including at least the number of bullet points, amount of text, and number of visual elements.

The term “user state information” refers to information acquired from sensors associated with a user, including at least facial information and voice information, which is used to determine an emotional state of the user.

The term “facial information” refers to image data or extracted feature data representing a user's face, including at least facial expressions or movements that can be analyzed to estimate emotion.

The term “voice information” refers to audio data or extracted acoustic feature data representing a user's speech or sounds, including at least pitch, volume, and prosody characteristics used for emotion estimation.

The term “emotion information” refers to structured data indicating an estimated emotional state of a user, including at least one of stress, excitement, relaxation, confusion, or other affective conditions, and optionally including intensity values or probabilities.

The term “terminal device” refers to a user-operated computing device, such as a personal computer, tablet, smartphone, or head-mounted display, capable of transmitting input information to the server and presenting editable presentation material data to the user.

The term “slide file format” refers to a digital file format designed to store presentation slides, such as a presentation document format that preserves slide structures, layouts, and embedded elements.

The term “electronic document format” refers to a digital file format for representing documents, including at least document formats capable of displaying text and embedded images in a fixed layout.

The term “editable form” refers to a state of presentation material data in which the user can modify at least text content, layout, or data visualization elements using software executed on the terminal device.

The term “time-series numerical data” refers to quantitative information indexed by time, such as numerical values associated with successive time intervals.

The term “category-based numerical data” refers to quantitative information grouped according to categories, such as product types, regions, or segments.

The term “ratio data” refers to quantitative information expressed as relative values, such as percentages, fractions, or proportions.

The term “audience attribute information” refers to qualitative information describing characteristics of intended recipients of a presentation, including at least role, expertise level, and demographic category.

The term “environmental condition information” refers to qualitative information describing conditions of a presentation environment, including at least location type, event type, and medium of delivery.

The term “atmosphere information” refers to qualitative information describing a desired or perceived mood of a presentation, such as formal, casual, energetic, or relaxing.

The term “tone information” refers to qualitative information defining a style of verbal and textual expression, such as persuasive, neutral, enthusiastic, or conservative.

The term “time allocation” refers to information specifying a duration for a presentation or for individual sections, including at least total presentation time and optionally time per slide or topic.

The term “expression style” refers to stylistic parameters indicating how content should be presented, including at least complexity level, level of detail, and usage of examples or narratives.

The term “time-series manner” refers to acquisition or processing performed repeatedly over time so that multiple measurements are associated with different time points.

The term “additional prompt sentence” refers to a prompt sentence generated after initial presentation material has been created, the prompt sentence including instructions to modify or regenerate at least part of existing slide content or explanatory text.

The term “updated presentation material data” refers to presentation material data that has been modified to reflect output of the generative AI model based on an additional prompt sentence and that replaces or augments corresponding portions of previous presentation material data.

In one embodiment, a server implements the claimed system as a network-connected presentation generation platform. The server includes a processor, a memory storing program instructions and data structures, a non-volatile storage device, and at least one network interface. The terminal includes at least one processor, a display, a camera, a microphone, local memory, and a communication interface. The user operates the terminal to provide inputs and to review and edit generated presentation material.

The server executes an application implemented, for example, as a web service using a framework such as a general-purpose web framework, and exposes an application programming interface (API) over a secure communication protocol such as HTTPS. The server stores user input data and generated presentation material in a data storage system, which may be implemented using a relational data management system. The server also stores trained model parameters for a generative AI model and an emotion determination model in the storage device.

The server implements a natural language processing module, a task information extraction module, a prompt generation module, a generative AI interaction module, a quantitative data processing module, a visualization generation module, a layout and formatting module, an emotion analysis module, and a presentation output module. Each module is realized as program instructions that, when executed by the processor, cause the processor to perform the functions described below.

The server uses the natural language processing module to process presentation themes and qualitative information. The server may use a language processing library to perform tokenization, sentence segmentation, part-of-speech tagging, and named entity recognition on natural language text. The server stores the results in a structured internal representation, such as a record that includes extracted key phrases, entities indicating roles (for example “executive management” or “high school students”), time expressions (for example “30 minutes”), and style descriptors (for example “formal”, “enthusiastic”, “simple”).

The server uses the task information extraction module to convert this structured representation into task information. The task information is stored, for example, as a JSON-like object or a set of database fields including a purpose field, an audience field, a time allocation field, and an expression style field. The server derives the time allocation field by normalizing extracted durations into seconds or minutes. The server derives the expression style field by mapping extracted adjectives or phrases to style labels, such as “high detail”, “low detail”, “technical”, and “non-technical”. By encoding the user's intent in this structured task information, the server enables subsequent modules to make deterministic decisions rather than relying on fixed templates; this structure reduces ambiguity and improves reuse across multiple generation cycles.

The server uses the quantitative data processing module to handle quantitative information. The server loads structured numerical data from a file or a request payload into an in-memory data frame structure. The server normalizes column names, infers data types (for example, floating point, integer, date/time), and handles missing values using predefined rules such as interpolation or deletion. The server calculates derived measures such as cumulative sums, percentage change, and moving averages. The server stores these processed data sets with identifiers linked to the task information and presentation themes so that the visualization generation module can efficiently access them without re-parsing the raw inputs. This explicit pre-processing improves computational efficiency and reduces repeated work during iterative content refinement.

The server uses the prompt generation module to construct a prompt sentence for a generative AI model. The server accesses the task information, the processed quantitative data, and the qualitative information, and composes a natural language instruction. The server inserts explicit constraints such as the number of slides, desired tone, and target audience into the instruction. The server also embeds summaries of the quantitative data, such as “Q1 forecast is 2.1 million units, Q2 forecast is 2.5 million units, annual growth is approximately 15 percent,” converted to textual form.

Examples of the prompt sentence generated by the server include:

“Create a 12-slide presentation for executive management on ‘New Product Market Analysis’. Use the following quantitative data: Q1 forecast 2.1M, Q2 2.5M, Q3 2.8M, Q4 3.0M, annual growth approximately 15%. The audience is senior executives, the duration is 30 minutes, and the tone should be formal and data-driven. Highlight three key opportunities and three main risks. Keep each slide simple with no more than three bullet points, use clear language, and suggest where to place line charts and bar charts.”

“Create a concise in-store sales presentation for introducing a new smartphone to a customer. The customer is interested in photography. Highlight a 50-megapixel camera, a 5000 mAh battery, and a price of 900 dollars. Use an energetic tone and emphasize cutting-edge camera features. Limit the presentation to 8 slides.”

“Create presentation materials for an introductory high-school physics lesson about Newton's laws. Use simple language, diagrams, and two or three practice problems per law. The duration is 45 minutes and the tone should be supportive and easy to understand.”

By constructing such context-rich prompt sentences, the server ensures that the generative AI model produces outputs that already satisfy many structural constraints. This reduces the number of times the server must call the generative AI model and minimizes downstream correction, thereby reducing latency and network traffic.

In one embodiment, the server implements the generative AI model as a sequence-to-sequence transformer neural network. The server stores model parameters corresponding to multiple layers of self-attention and feed-forward sub-layers. Each layer includes multi-head attention mechanisms configured with a fixed number of attention heads, key and value dimensions, and feed-forward network width. The server trains this model off-line using a large corpus of presentation-like texts, slide outlines, and annotated examples that specify slide counts, audience types, and tones. During training, the server uses a cross-entropy loss function between generated token sequences and reference sequences. The server updates model weights using a gradient-based optimization algorithm such as an adaptive moment estimation method. The server may perform data augmentation by varying slide counts, rephrasing objectives, or swapping in equivalent data sets to teach the model how to respond consistently to different task parameters.

At inference time, the server passes the prompt sentence through a tokenizer, encodes tokens as embedding vectors, and propagates them through the transformer layers. The server uses beam search or nucleus sampling with specified parameters to generate output tokens. The server constrains generation to adhere to structural tokens indicating slide boundaries, bullet markers, and chart references, such as “[SLIDE]”, “[TITLE]”, “[BULLET]”, and “[CHART: line]”. The server parses the generated sequence, splits content by these tokens, and builds presentation material candidate information in an internal data structure. This structure explicitly defines slide order, titles, bullet text, required chart types, and locations for explanatory notes. By defining specific control tokens and by parsing output into structured fields, the server transforms a generic language model into a deterministic content generator with predictable slide-level structure, which is a technical improvement over ad-hoc text generation.

The server uses the visualization generation module to convert data set entries into data visualization elements. The server selects a visualization type based on the characteristics of the data (for example, continuous time-series data versus categorical data) and on the task information (for example, requirement to highlight trends versus distribution). The server implements decision rules such as mapping time-series with more than a threshold number of points to line graphs, mapping categorical totals to bar graphs, and mapping percentage breakdowns to pie charts. The server uses a graphical library to render the selected charts. The server sets axis limits by computing data minima and maxima and adding margins, chooses tick spacing based on data range, and maps colors from a style palette determined by expression style and audience. The server stores rendered graphs, tables, and figures as raster or vector images, and maintains references to these images in the presentation material data structure.

The server uses the layout and formatting module to assemble complete presentation material data. The server selects a template corresponding to the audience and expression style, such as an “executive template” with formal colors and a “student template” with larger fonts and more icons. The server uses algorithmic rules to control information density. For example, the server estimates reading time for each slide by counting characters in bullet points and dividing by an average reading speed; if estimated reading time exceeds a threshold derived from the time allocation field, the server splits content into additional slides or removes less important bullets based on ranking of key phrases. The server computes positions for each element using constraints such as minimum margins, maximum text width, and non-overlap with charts, and then writes all elements into a slide representation, which can be converted into a slide file format or an electronic document format.

The server uses the emotion analysis module to process user state information. The terminal captures facial images via the camera and audio via the microphone while the user prepares or delivers a presentation. The terminal compresses these signals and transmits them to the server at predefined intervals. The server extracts facial features using a convolutional neural network trained for expression recognition. The network may include convolutional layers, pooling layers, and fully connected layers that output probabilities for emotion labels such as “stress”, “joy”, “confusion”, and “relaxation”. The server also extracts speech features using a recurrent or transformer-based network configured to accept sequences of acoustic feature vectors such as Mel-frequency cepstral coefficients, pitch, and energy values.

The server combines facial and voice-derived probabilities using a weighted fusion algorithm. The server stores the resulting emotion information as a time-stamped sequence associated with the current presentation. The server smooths the sequence using a temporal filter such as an exponential moving average and identifies segments where a specific emotion exceeds a threshold. For example, the server may detect a high “stress” region when the averaged stress probability remains above a predetermined value for a certain duration.

The server integrates this emotion information back into prompt generation and layout decisions. When the server detects high stress during preparation, the server inserts additional constraints into the prompt sentence such as “keep explanations simple” or “avoid complex jargon”. When the server detects confusion during a particular portion of a live presentation, the server generates an additional prompt sentence that refers to the slide identifier and requests simplification or added examples, such as “Simplify the explanation on slide 3. Reduce the number of bullet points to three and add a concrete example illustrating the concept.” The server sends this additional prompt sentence to the generative AI model, receives replacement content for the affected slide, regenerates the slide image or slide file segment, and sends an updated version to the terminal. By selectively regenerating only specific segments of the presentation material, the server reduces the amount of data that must be recomputed and transmitted, thereby decreasing processing load and network bandwidth consumption.

The terminal presents the generated presentation material data to the user. The terminal may display slide thumbnails, full-screen slide views, and editing controls. The terminal allows the user to directly modify text, reposition graphics, and select alternative styles using local editing software or a client-side web application. When the user confirms the presentation, the terminal may store a local copy while the server stores a master copy and associated metadata. During live delivery, the terminal may display the slides on an external display, on a head-mounted display, or within a web conferencing application. The terminal can periodically receive updated slides from the server when the server performs emotion-based adjustments.

This architecture produces several technical effects. First, by representing user intent as explicit task information and embedding that information into structured prompt sentences, the server reduces the number of model invocations and the need for repeated trial-and-error generations. This reduces average processing time and improves responsiveness. Second, by pre-processing quantitative information and caching derived measures, the server avoids recalculating data summaries for each generation, reducing CPU load and memory bandwidth requirements. Third, by using structured control tokens and parsing the generative AI output into explicit slide fields, the server performs deterministic mapping from free-form text to machine-usable presentation structures, which is not achievable by a naive text generation system.

Fourth, by integrating real-time emotion information into both the prompt generation and the layout optimization algorithm, the server adaptively controls information density and presentation style in a way that cannot be achieved by static templates. Because the server uses quantitative thresholds and structured emotion scores, the system can programmatically balance slide complexity against allotted time and detected stress level, resulting in better alignment with the user's cognitive state and reduction of overload. Fifth, by selectively regenerating only affected slides or sections based on localized emotion changes, the server minimizes unnecessary re-rendering and transmission, which reduces communication overhead and accelerates updates during live presentations.

In another embodiment, the server replaces the transformer-based generative AI model with a hybrid model that combines a rule-based planner and a neural language generator. The rule-based planner determines slide count, section structure, and which data visualization elements are required, based on the task information and processed quantitative data. The neural language generator then fills in textual content for each planned section. This alternative configuration still uses a prompt sentence internally to instruct the language generator but offloads structural planning to a deterministic algorithm. This variation demonstrates that the invention is not limited to a specific neural architecture.

In yet another embodiment, the emotion analysis module is implemented entirely on the terminal for privacy reasons. The terminal runs a local neural network for emotion estimation and sends only abstract emotion scores, not raw images or audio, to the server. The server then uses these scores in the same way as described above. This configuration reduces the amount of sensitive data transmitted over the network while preserving the technical effects of emotion-adaptive content generation.

In still another embodiment, the server uses different visualization engines or document formats, such as vector-based drawing libraries or alternative slide formats. The core processing steps remain the same: extraction of task information, generation of context-rich prompt sentences, invocation of a generative AI model under structural constraints, quantitative data processing, visualization selection and rendering, emotion-aware layout control, and selective regeneration. Because the system is structured around internal data representations and modular processing pipelines, the server can adapt to different hardware resources and deployment environments while preserving the described technical advantages.

Through these embodiments, the server, terminal, and user cooperate to implement a system that goes beyond mere automation of human drafting. The system restructures inputs into machine-optimized representations, controls complex neural models with explicit constraints, and tightly integrates emotion-aware feedback into an adaptive computational pipeline. As a result, the system improves processing efficiency, reduces unnecessary network transmissions, enhances consistency of generated output with user constraints, and provides a technical improvement in the functioning of computer-implemented presentation generation.

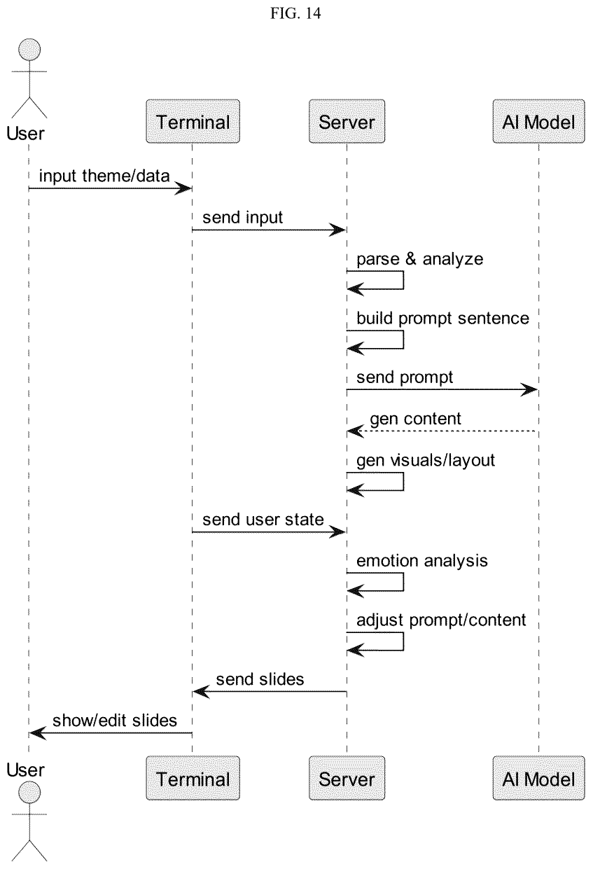

The following describes the processing flow using FIG. 14.

### Step 1:

User operates the terminal to input initial presentation information.

User enters a presentation theme as free-form natural language text, such as “New Product Market Analysis for Executive Management.”

User inputs quantitative information by typing numerical values into numeric fields or by selecting and uploading files that contain time-series or category-based numerical data.

User inputs qualitative information by selecting options such as target audience, environment, desired tone, and atmosphere, and by optionally entering additional descriptive text.

Input: raw user inputs including theme text, quantitative values or data files, and qualitative selections or descriptions.

Output: a request payload containing the user's inputs in a structured format (for example, a JSON object or form data) sent from the terminal to the server.

### Step 2:

Terminal packages and transmits the user inputs to the server.

Terminal validates basic input formats (for example, non-empty fields, numeric characters for numeric fields, allowed file types) and constructs a message including the theme, quantitative information, qualitative information, and user identifier.

Terminal sends this message to the server using a secure protocol such as HTTPS.

Input: user input values residing in the terminal's memory.

Output: a network request carrying structured input data from the terminal to the server.

### Step 3:

Server receives and stores the structured input data.

Server parses the request payload and maps each field to internal variables or database columns (for example, ‘theme_text’, ‘raw_numeric_data’, ‘audience_type’).

Server temporarily stores the raw data in memory for processing and may persist a copy in a data storage system.

Input: structured input data received from the terminal.

Output: normalized internal data structures containing raw theme text, raw quantitative data, and raw qualitative attributes, ready for analysis.

### Step 4:

Server performs natural language processing on the theme text and qualitative text.

Server uses a language processing module to tokenize the theme and qualitative descriptions, perform sentence segmentation, part-of-speech tagging, and named entity recognition.

Server identifies key phrases, such as “market analysis,” “executive management,” “30 minutes,” and “formal tone,” and assigns them to predefined categories.

Input: raw text for the presentation theme and qualitative descriptions.

Output: an intermediate linguistic annotation structure including tokens, tags, and extracted key phrases and entities.

### Step 5:

Server extracts task information from the linguistic annotation structure.

Server maps recognized phrases and entities to task fields: for example, “executive management” is mapped to the audience field, “30 minutes” is converted to a numerical time allocation, and “formal tone” is mapped to an expression style label.

Server aggregates these fields into a task information object that encodes purpose, target audience, time allocation, and expression style.

Input: intermediate linguistic annotation structure produced in Step 4.

Output: task information object containing structured fields such as purpose, audience, duration, and style.

### Step 6:

Server preprocesses quantitative information into a normalized data set.

Server loads raw numerical data (for example, uploaded time-series or category-based values) into an in-memory data frame structure.

Server converts strings to numeric types, parses dates to time objects, handles missing values using predetermined rules (such as interpolation or removal), and computes derived metrics such as totals, averages, growth rates, and ratios.

Input: raw quantitative data from Step 3.

Output: a processed data set with normalized schema and derived numerical metrics suitable for visualization and summarization.

### Step 7:

Server correlates the task information with the processed data set.

Server links quantitative measures to narrative goals specified in the task information, such as identifying which metrics are relevant to risks, opportunities, or performance trends.

Server tags each derived metric with semantic labels (for example, “key growth indicator” or “baseline comparison”) based on rules that compare metric values against thresholds or historical averages.

Input: task information from Step 5 and processed data set from Step 6.

Output: a semantically annotated data set aligned with the presentation purpose and audience.

### Step 8:

Server generates a context-rich prompt sentence for the generative AI model.

Server composes a natural language instruction that includes the presentation theme, the task information fields, summaries of the key numerical metrics, and constraints such as the desired number of slides and tone.

Server inserts explicit guidance such as “use no more than three bullet points per slide” or “highlight three key opportunities and three main risks,” derived from the audience and time allocation.

Input: task information object and semantically annotated data set.

Output: a prompt sentence in natural language that encodes structural, stylistic, and data-related constraints for the generative AI model.

### Step 9:

Server sends the prompt sentence to the generative AI model and obtains generated text.

Server tokenizes the prompt sentence, feeds the tokens into the generative AI model (for example, a transformer-based neural network), and configures generation parameters such as maximum length and sampling strategy.

Server receives a sequence of output tokens representing proposed slide structures, titles, bullet points, and references to visual elements.

Input: prompt sentence from Step 8.

Output: raw generated token sequence or text representing draft presentation content.

### Step 10:

Server parses the generated text into presentation material candidate information.

Server identifies structural markers in the generated text (for example, explicit slide delimiters or pattern-based headings) and splits the text into slide-level segments.

Server extracts slide titles, bullet lists, notes, and indications of required charts or figures, and stores them in a structured object representing presentation material candidate information.

Input: raw generated text from Step 9.

Output: presentation material candidate information object with explicit slide definitions and content fields.

### Step 11:

Server selects visualization types and generates data visualization elements.

Server examines the semantically annotated data set and the visualization requests indicated in the presentation material candidate information (for example, “line chart for quarterly sales”).

Server applies selection rules mapping data characteristics to visualization types, then constructs charts, tables, or figures using a graphics library by converting numerical series and categories into coordinates, labels, and graphical marks.

Input: semantically annotated data set from Step 7 and visualization requests from Step 10.

Output: rendered data visualization elements (for example, images or vector graphics) and references linking them to corresponding slides.

### Step 12:

Server assembles presentation material data with layout and formatting.

Server chooses a layout template based on audience and expression style, then places titles, bullet text, and visualization elements on each slide according to layout constraints (margins, alignment, and relative positions).

Server calculates information density per slide by counting text length and number of elements, compares it against thresholds derived from time allocation, and splits or condenses content when necessary.

Input: presentation material candidate information from Step 10 and visualization elements from Step 11.

Output: complete presentation material data structure describing slides with layout parameters, text, and embedded visuals.

### Step 13:

Terminal acquires user state information for emotion analysis.

Terminal activates the camera and microphone, captures facial images and voice segments at defined intervals while the user prepares or rehearses, and compresses these streams into a format suitable for transmission.

Terminal attaches identifiers linking the captured data to the current presentation session and sends them to the server.

Input: live sensor data (images and audio) captured from the user.

Output: encoded user state information transmitted to the server.

### Step 14:

Server analyzes user state information to compute emotion information.

Server feeds facial images into an emotion recognition network that outputs probabilities for emotional categories and feeds acoustic features from voice into a complementary model.

Server fuses these outputs over time using a temporal smoothing algorithm to derive a time-series of emotion scores, then summarizes these scores into current emotion information such as “high stress” or “high excitement.”

Input: encoded user state information from Step 13.

Output: emotion information object representing estimated emotional state of the user.

### Step 15:

Server adjusts prompt sentence content and layout parameters based on the emotion information.

Server evaluates whether the current emotion state triggers adaptation rules, such as reducing slide complexity when stress is high or increasing emphasis on certain features when excitement is high.

Server modifies the existing prompt sentence or generates an additional prompt sentence that instructs the generative AI model to simplify explanations, change tone, or add examples for specific slides.

Input: emotion information from Step 14 and existing prompt sentence or presentation material data.

Output: adjusted or additional prompt sentence and updated layout parameters reflecting emotion-aware constraints.

### Step 16:

Server regenerates or refines portions of the presentation material data using the adjusted prompt sentence.

Server submits the adjusted prompt sentence to the generative AI model, requesting content only for specified slides or sections, and receives revised text.

Server replaces or augments the corresponding segments in the presentation material candidate information and, if necessary, regenerates affected visualization or layout sections to accommodate changes in text length or emphasis.

Input: adjusted or additional prompt sentence from Step 15 and current presentation material data.

Output: updated presentation material data incorporating emotion-aware content adjustments.

### Step 17:

Server converts the presentation material data into one or more output formats and transmits them.

Server renders the slide structure, layout, text, and visual elements into a slide file format and/or an electronic document format, embeds all required resources, and stores the files in persistent storage.

Server generates a response that includes either the binary file content or secure download links and sends this response to the terminal.

Input: finalized presentation material data from Step 12 or Step 16.

Output: formatted presentation files or links transmitted to the terminal.

### Step 18:

Terminal presents the generated presentation files in an editable and viewable form.

Terminal downloads the files or receives them directly from the server, opens them in a local presentation viewer or editor, and displays slide thumbnails and full views to the user.

Terminal allows the user to adjust text, rearrange elements, and, if desired, reupload a modified version to the server for storage or further processing.

Input: presentation files or access links from Step 17.

Output: on-screen presentation of slides and optional edited files saved locally or sent back to the server.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

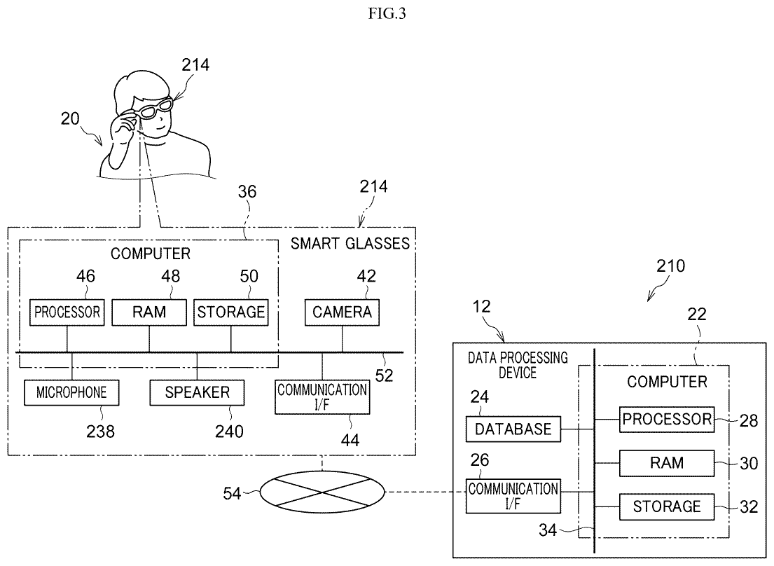

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

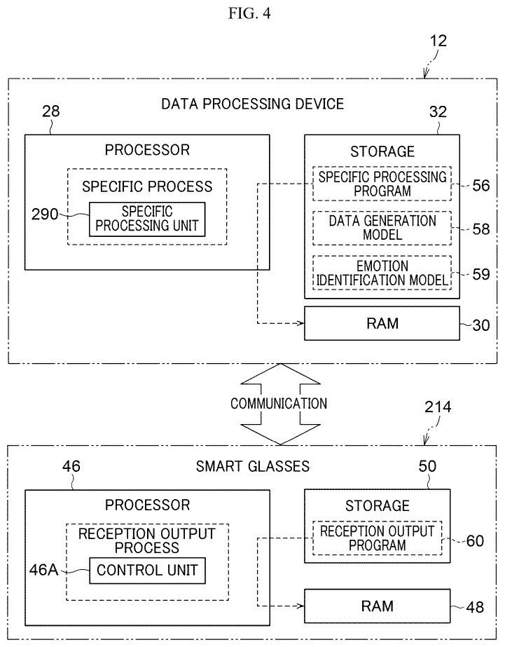

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

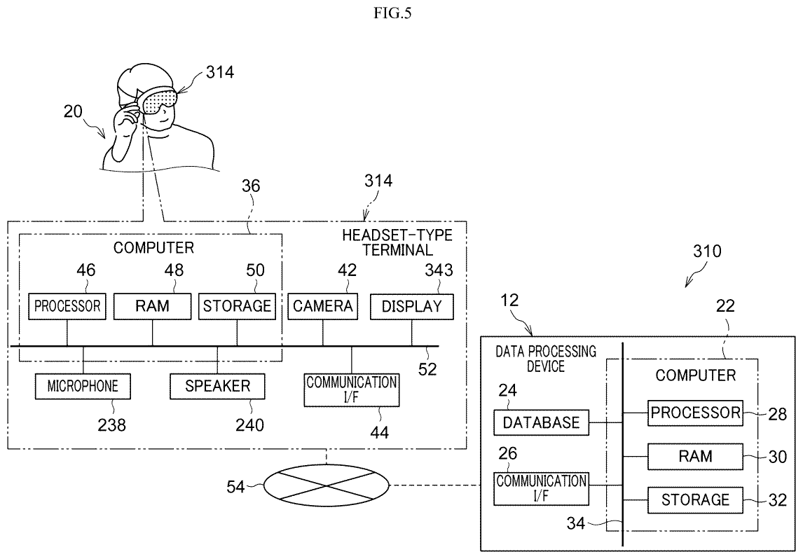

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

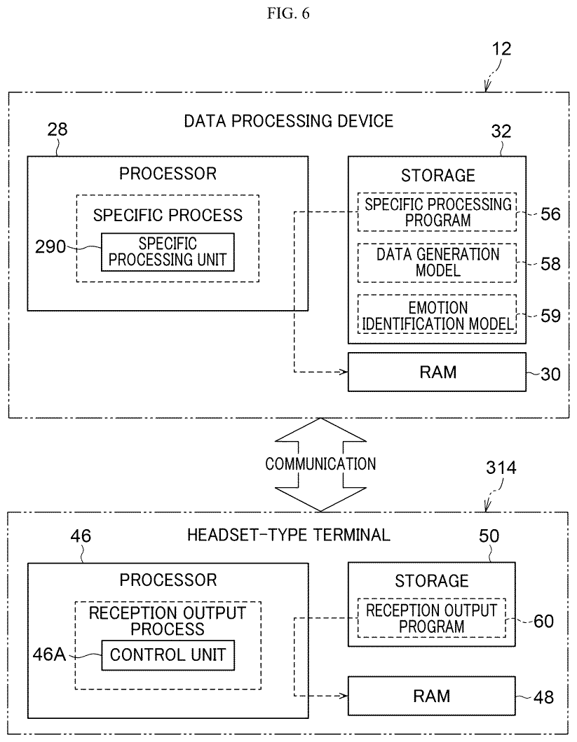

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

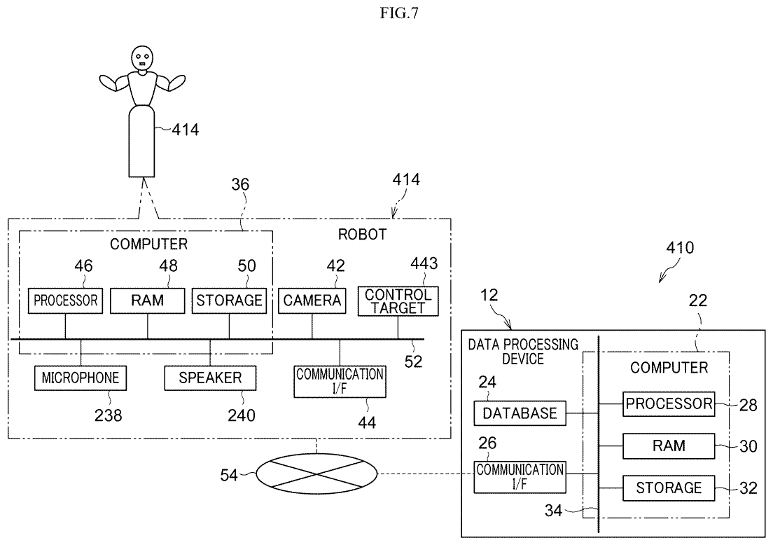

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

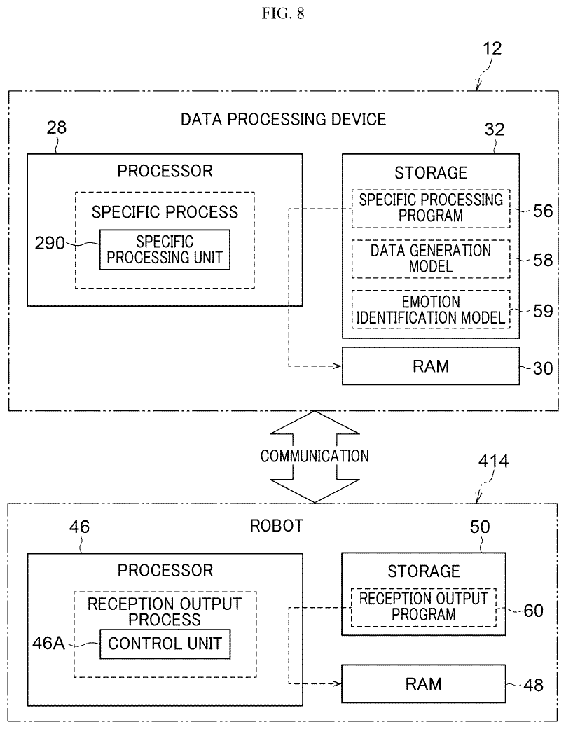

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

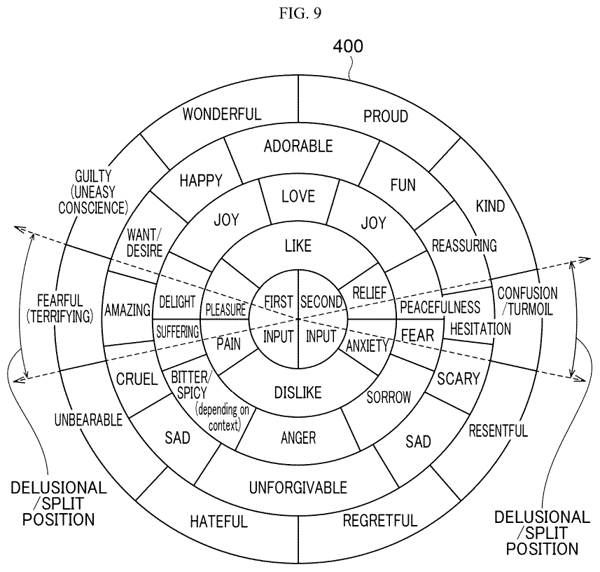

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

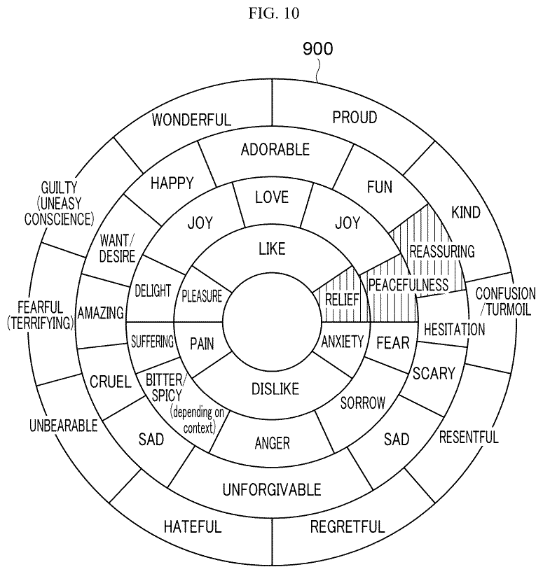

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
cause a user terminal to display an input screen that enables a user to input, via the user terminal, character information representing a presentation subject, numerical information, and selection information,
receive, from the user terminal via a network, the character information, the numerical information, and the selection information, and store the received character information, numerical information, and selection information as structured data in a storage device,
generate, on the basis of the structured data stored in the storage device, a natural language prompt sentence for instructing generation of presentation material, by using a predefined sentence template and string manipulation processing,
input the prompt sentence into a generative AI model that generates text information by using natural language processing, and obtain, from the generative AI model, presentation-material text including slide-level structure and bullet-point information,
analyze the presentation-material text to generate slide-structure data including slide titles, bullet-point items, and explanatory sentences, and generate, on the basis of the slide-structure data, presentation material in an electronic file format or a web display format,
provide the generated presentation material to the user terminal in a state in which the presentation material is downloadable or viewable so that the user can obtain the presentation material,
acquire information relating to an emotional state of the user, and, in accordance with the emotional state, adjust content of at least one of the prompt sentence and the presentation-material text so as to change at least one of an expression style and an information amount of the presentation material.

### (Supplementary 2)

The system according to supplementary 1,
wherein the processor is configured to store, as the structured data, the numerical information including presentation time, statistical values, ratio values, index values, and other quantitative data, and to store, as the structured data, the selection information including classification information relating to at least one of a target field, a target group, environmental conditions, an expression policy, a visualization style, and a detail level, and wherein, in the generation of the prompt sentence, the processor is configured to convert the quantitative data and the classification information into natural language explanatory text and insert the natural language explanatory text into the prompt sentence.

### (Supplementary 3)

The system according to supplementary 1,
wherein the processor is configured to, in generating the presentation material, automatically determine, on the basis of the slide-structure data, at least one of a data visualization style, a layout structure, a text decoration, and a section structure suitable for a theme and a target of the presentation material, and, further in accordance with the emotional state of the user, customize at least one of a detail level of explanatory sentences, a tone of wording, emphasis portions, a number of slides, and a density of bullet points.

### Application Example 1

### (Supplementary 1)

A system comprising a processor,
wherein the processor is configured to
receive, via a terminal, information indicating a presentation theme and purpose, quantitative information, and qualitative information from a user,
obtain, from the terminal, structured information files including work performance information and quality evaluation information related to an industrial process, convert the structured information files into tabular data, and perform missing-value processing, outlier processing, aggregation processing, and index-calculation processing on the tabular data to generate analysis data,
integrate the information indicating the presentation theme and purpose, the quantitative information, and the qualitative information with summary information and performance indicators calculated from the analysis data, and construct a prompt sentence as an input sentence for generative processing,
input the prompt sentence to a generative AI model and cause the generative AI model to generate presentation-material candidate text including improvement plans for work planning and quality improvement plans for the industrial process,
segment the presentation-material candidate text into plural display units including explanatory sections, list sections, and heading sections, and associate numerical information and visualization information based on the analysis data with the respective display units, generate a document for visual presentation based on the structured presentation material and provide the document to the user via the terminal, and
adjust a presentation order, an information amount, and an expression format of the generated presentation material in accordance with an emotional state of the user.

### (Supplementary 2)

The system according to supplementary 1,
wherein the processor is configured to treat the structured information files as data groups including time-based or period-based performance information of production activities of the industrial process and quality evaluation information for each product or process, to generate the analysis data including a production-efficiency indicator, a defect-rate indicator, and an operation-status indicator calculated from the performance information and the quality evaluation information, and to cause the generative AI model to generate the presentation material based on the indicators.

### (Supplementary 3)

The system according to supplementary 1,
wherein the processor is configured to construct the prompt sentence to include the presentation theme and purpose, the quantitative information, the qualitative information, a data summary including the production-efficiency indicator, the defect-rate indicator, and the operation-status indicator, and instruction text specifying an information structure, a display format, and contents of improvement plans to be generated by the generative AI model.

### EXAMPLE 2

### (Supplementary 1)

A system comprising a processor,
wherein the processor is configured to
receive, from a user, presentation information including a theme, an objective, a target audience, environment information, quantitative information, and qualitative information,
analyze structured information included in the quantitative information to extract a data type, time information, classification information, and measurement values, and determine candidate data representation methods corresponding to the structured information,
analyze natural language information included in the qualitative information to extract keywords, important phrases, and a presentation type, and determine structural elements and a logical structure of a presentation material,
automatically determine a visualization specification including a graph type, axis items, aggregation methods, and a layout based on the candidate data representation methods and the structural elements of the presentation material, and generate data visualization images in accordance with the visualization specification,
automatically determine a document format specification including color scheme, font, font size, and background style based on the environment information and the target audience,
generate a prompt sentence including the theme, the objective, the target audience, the structural elements of the presentation material, the visualization specification, and the document format specification, input the prompt sentence to a generative AI model, and obtain text information including a section structure of the presentation material, slide titles, and bullet-point contents,
format the text information to satisfy a predetermined length and style, and combine the formatted text information with the data visualization images and the document format specification to automatically generate the presentation material as an electronic presentation document, and
adjust at least one of expressions in the text information and the document format specification based on emotion state information of the user.

### (Supplementary 2)

The system according to supplementary 1,
wherein the processor is configured to
generate a plurality of kinds of the data visualization images, input to the generative AI model a prompt sentence including the plurality of kinds of the data visualization images and candidate explanatory texts corresponding thereto, and, based on a response from the generative AI model, select, on a slide-by-slide basis, a data representation method and an explanatory text to be used, thereby automatically optimizing a structure of the presentation material.

### (Supplementary 3)

The system according to supplementary 1,
wherein the processor is configured to
store the prompt sentence and the text information obtained from the generative AI model in association with evaluation information or feedback information received from the user, and update generation rules for the prompt sentence and decision rules for the data representation methods based on a storage result, thereby adaptively improving subsequent presentation material generation processing.

### Application Example 2

### (Supplementary 1)

A system comprising a processor,
wherein the processor is configured to
receive, from a user, information including a presentation theme, quantitative information, and qualitative information,
analyze the information by performing natural language processing to extract task information indicating at least a purpose, a target audience, a time allocation, and an expression style for presentation material,
generate, based on the task information and the quantitative information, a prompt sentence in a natural language format to be input to a generative AI model,
input the prompt sentence to the generative AI model and obtain presentation material candidate information including at least a slide structure, text information, and specification of visual elements,
perform statistical processing and aggregation processing on the quantitative information to generate a data set associated with the presentation theme and the presentation material candidate information,
generate, based on the data set, data visualization elements including at least one of a graph, a table, and a figure,
generate presentation material data by determining, based on the presentation material candidate information and the data visualization elements, at least one of layout, font, color, and information density on a per-slide basis,
acquire user state information including at least facial information and voice information and calculate emotion information indicating an emotional state of the user based on the user state information,
dynamically adjust, according to the emotion information, at least one of a content of the prompt sentence, the data visualization elements, and the presentation material data, and
output the presentation material data in at least one of a slide file format and an electronic document format, transmit the presentation material data to a terminal device, and present the presentation material data in an editable form on the terminal device.

### (Supplementary 2)

The system according to supplementary 1,
wherein the processor is configured to
treat the quantitative information as numerical information including at least presentation time information, time-series numerical data, category-based numerical data, and ratio data,
treat the qualitative information as non-numerical information including at least audience attribute information, environmental condition information, atmosphere information, and tone information,
select, based on the quantitative information, at least one type and scale of the data visualization elements, and
determine, based on the qualitative information and the emotion information, at least one of a color scheme, a layout, and an amount of text for the presentation material data.

### (Supplementary 3)

The system according to supplementary 1,
wherein the processor is configured to
acquire the emotion information in a time-series manner during execution of a presentation,
generate, according to a change in the emotion information, an additional prompt sentence for the generative AI model,
cause the generative AI model to regenerate, based on the additional prompt sentence, at least a part of slide content or explanatory text included in the presentation material data, and transmit updated presentation material data reflecting a result of the regeneration to the terminal device in real time.

What is claimed is:

1. A system comprising:
circuitry configured to:
acquire, via a communication interface coupled to a packet-switched network, input data from a terminal device, the input data comprising structured numerical data and unstructured text data associated with a content generation request;
analyze the structured numerical data to extract data type classifications, temporal attributes, and measurement values, and determine candidate data representation methods comprising visualization type selections and axis mapping specifications;
execute a natural language processing operation on the unstructured text data to extract keyword data, phrase importance scores, and a content type classification, and determine structural element data comprising section identifiers and a logical ordering;
compute a visualization specification comprising a graph type, axis item assignments, aggregation method selections, and a layout configuration based on the candidate data representation methods and the structural element data, and generate data visualization image data in accordance with the visualization specification;
construct a prompt data structure comprising the structural element data, the visualization specification, a formatting specification, and constraint parameters, and transmit the prompt data structure to a generative neural network model comprising a transformer-based architecture to acquire generated text data comprising section structure data, title data, and content item data;
execute a formatting operation on the generated text data to enforce length constraints and style normalization, and combine the formatted text data with the data visualization image data and the formatting specification to generate composite document data; and
transmit the composite document data to the terminal device via the communication interface.

2. The system according to claim 1, wherein the circuitry is further configured to analyze the structured numerical data by detecting column data types from header metadata, computing statistical summary values comprising mean, median, variance, and range for each numerical column, and selecting the candidate data representation methods based on a mapping between detected data type patterns and predefined visualization rules.

3. The system according to claim 2, wherein the circuitry is further configured to generate a plurality of candidate data visualization image data sets using different visualization types for the same structured numerical data, construct a selection prompt comprising the plurality of candidate data visualization image data sets and candidate explanatory text, transmit the selection prompt to the generative neural network model, and select a data representation method based on a response from the generative neural network model.

4. The system according to claim 1, wherein the natural language processing operation further comprises tokenization, part-of-speech tagging, dependency parsing, and named entity recognition on the unstructured text data, and the phrase importance scores are computed using a term frequency-inverse document frequency weighting.

5. The system according to claim 4, wherein the circuitry is further configured to determine the content type classification from the extracted keyword data and phrase importance scores by inputting feature vectors derived from the keyword data into a classification model that outputs a content type label from a set comprising informational, analytical, persuasive, and comparative types.

6. The system according to claim 1, wherein the formatting specification comprises a color scheme, font family, font size, and background style parameters determined based on environment attribute data and audience attribute data included in the input data.

7. The system according to claim 6, wherein the circuitry is further configured to select the formatting specification from a plurality of stored formatting templates by computing a similarity score between the environment attribute data and template attribute data associated with each stored formatting template.

8. The system according to claim 1, wherein the circuitry is further configured to acquire affective state data from the terminal device, input the affective state data into an emotion identification model to compute an emotion category and an emotion intensity value, and adjust at least one of the generated text data and the formatting specification based on the emotion category.

9. The system according to claim 8, wherein the affective state data comprises at least one of facial image data, voice spectrogram data, or biometric signal data, and the emotion identification model comprises a multimodal neural network that fuses features extracted from the at least one of the facial image data, the voice spectrogram data, or the biometric signal data.

10. The system according to claim 8, wherein the circuitry adjusts the generated text data by modifying an expression complexity level when the emotion category indicates a negative affective state, and adjusts the formatting specification by modifying a color saturation parameter and a font size parameter when the emotion category indicates an anxious affective state.

11. The system according to claim 1, wherein the circuitry is further configured to segment the composite document data into a plurality of page units, each page unit comprising a title region, a content region, and a visualization region, and arrange content within each region according to the structural element data and the layout configuration.

12. The system according to claim 11, wherein the circuitry is further configured to compute a content density metric for each page unit, and when the content density metric exceeds a threshold, redistribute content items across adjacent page units to maintain readability constraints.

13. The system according to claim 1, wherein the circuitry is further configured to store the prompt data structure and the generated text data in the information storage device in association with evaluation data received from the terminal device, and update generation rules for the prompt data structure and decision rules for the candidate data representation methods based on the evaluation data.

14. The system according to claim 13, wherein the circuitry is further configured to compute a generation quality score from the evaluation data, compare the generation quality score against historical generation quality scores stored in the information storage device, and adjust prompt template parameters to increase the generation quality score in subsequent generation operations.

15. The system according to claim 1, wherein the circuitry is further configured to generate the composite document data as an electronic presentation file conforming to a standardized document format, the electronic presentation file comprising a plurality of slides each containing the formatted text data and the data visualization image data.

16. The system according to claim 1, wherein the circuitry is further configured to acquire additional input data from external information providing apparatuses via the communication interface, extract supplementary data values from the additional input data, and incorporate the supplementary data values into the visualization specification and the prompt data structure.

17. The system according to claim 1, wherein the input data comprises sales performance data as the structured numerical data and a quarterly business review theme as the unstructured text data, the visualization specification comprises bar chart and trend line selections, and the composite document data comprises a business presentation document.

18. A system comprising:
circuitry configured to:
acquire input data comprising structured numerical data and unstructured text data from a terminal device via a communication interface;
analyze the structured numerical data to determine candidate data representation methods and analyze the unstructured text data using natural language processing to determine structural element data;
compute a visualization specification and generate data visualization image data based on the candidate data representation methods;
construct a prompt data structure comprising the structural element data and the visualization specification, transmit the prompt data structure to a generative neural network model, and acquire generated text data;
combine the generated text data with the data visualization image data to generate composite document data; and
transmit the composite document data to the terminal device.

19. The system according to claim 18, wherein the circuitry is further configured to acquire affective state data from the terminal device, compute an emotion category using an emotion identification model, and adjust the generated text data or a formatting specification based on the emotion category.

20. A method performed by circuitry via a communication interface coupled to a packet-switched network, the method comprising:
acquiring input data from a terminal device, the input data comprising structured numerical data and unstructured text data;
analyzing the structured numerical data to extract data type classifications, temporal attributes, and measurement values, and determining candidate data representation methods;
executing a natural language processing operation on the unstructured text data to extract keyword data, phrase importance scores, and a content type classification, and determining structural element data;
computing a visualization specification and generating data visualization image data in accordance with the visualization specification;
constructing a prompt data structure comprising the structural element data, the visualization specification, and constraint parameters, and transmitting the prompt data structure to a generative neural network model comprising a transformer-based architecture to acquire generated text data;
executing a formatting operation on the generated text data and combining the formatted text data with the data visualization image data to generate composite document data; and
transmitting the composite document data to the terminal device.
